(19) United States
(12) Patent Application Publication
(10) Pub. No.: US 2024/0226911 A1
(43) Pub. Date: Jul. 11, 2024

(54) JET MILL DEVICE

(71) Applicant: Isaac Corporation, Kiryu-shi (JP)

(72) Inventor: Isao OKAWA, Oura-gun (JP)

(21) Appl. No.: 18/615,583

(22) Filed: Mar. 25, 2024

Related U.S. Application Data
(63) Continuation of application No. PCT/JP21/38428, filed on Oct. 18, 2021.

(51) Int. Cl. B02C 19/06

(52) U.S. Cl. CPC B02C 19/06

(57) ABSTRACT

A jet mill device comprises a cavity chamber for pulverizing a material to be pulverized into a fine powder, an inner surface of the cavity chamber being formed of a material having a hardness higher than a hardness of the material to be pulverized, and an air flow generator for generating an air flow swirled in the cavity chamber. The material to be pulverized fed into the cavity chamber is swirled by the air flow generated by the air flow generator and collides with the inner surface of the cavity chamber, thereby the material to be pulverized is pulverized into the fine powder. Even highly hard materials can be pulverized.

### CROSS-REFERENCE TO RELATED APPLICATION

This application is a continuation application of International Application No. PCT/JP2021/038428 filed on Oct. 18, 2021. The content of the prior application is herein incorporated by reference in its entirety.

### TECHNICAL FIELD

The present invention relates to a jet mill device that pulverizes material to be pulverized into fine powder.

### BACKGROUND ART

As a conventional fine milling device, a fine milling device in which a rotor is housed in a casing with an opening formed in the casing, a material to be pulverized is fed into the casing from a cylindrical body, and the material is pulverized into fine powder by rotation of the rotor, wherein the rotor is supported by a support frame attached to the rotary drive shaft of a drive motor at a predetermined interval in the direction of the central axis of rotation, and wherein an air gap is formed between the rotor blades and the rotor plate, which is connected from the central opening to the outer edge, is known (see Patent Reference 1).

### PRIOR ART REFERENCES

### Patent References

Patent Reference 1: Japanese Patent Application Unexamined Publication No. 2016-087501

### SUMMARY OF THE INVENTION

### Problems to be Solved by the Invention

However, in the conventional fine milling device, when attempting to pulverize hard and large particle size materials, the rotating blades and rotating plates could be damaged by the hard materials, or the inner surface of the casing could be scraped by the hard materials and could be mixed into the product fine powder.

The purpose of the present invention is to provide a jet mill device that can pulverized even a highly hardened material to be pulverized.

### Means for Solving the Problem

The jet mill device according to one aspect of the present invention is characterized in that the jet mill device comprises a cavity chamber for pulverizing a material to be pulverized into a fine powder, an inner surface of the cavity chamber being formed of a material having a hardness higher than a hardness of the material to be pulverized, and an air flow generator for generating an air flow swirled in the cavity chamber, wherein the material to be pulverized fed into the cavity chamber is swirled by the air flow generated by the air flow generator and collides with the inner surface of the cavity chamber, thereby the material to be pulverized is pulverized into the fine powder.

In the jet mill device described above, it is also possible that the jet mill device further comprises a rotor body having a flat plate rotor rotating within the cavity chamber, a surface of the flat plate rotor being formed of a material having a higher hardness than that of the material to be pulverized, wherein the material to be pulverized fed into the cavity chamber is swirled by the air flow generated by the air flow generator and collides the inner surface of the cavity chamber and the surface of the flat plate rotor, thereby the material to be pulverized is pulverized into the fine powder.

In the jet mill device described above, it is also possible that the rotor body is formed by alternately stacking the flat plate rotor and a spacer, and a diameter of the spacer is smaller than a diameter of the flat plate rotor.

In the jet mill device described above, it is also possible that a plurality of notches are formed on an outer circumference of the flat plate rotor of the rotor body.

In the jet mill device described above, it is also possible that a plurality of stages of the cavity chamber and the air flow generator are stacked via a partition plate, and that the partition plate has an opening for leading the fine powder pulverized in the cavity chambers in a lower stage to the cavity chambers in an upper stage.

In the jet mill device described above, it is also possible that at least three or more stages of the cavity chamber and the air flow generator are stacked via the partition plate, and that a diameter of the opening of the partition plate positioned between a first stage of the cavity chamber and the air flow generator, and a second stage of the cavity chamber and the air flow generator is smaller than a diameter of the opening of the partition plate positioned between the second stage of the cavity chamber and the air flow generator, and a third stage of the cavity chamber and the air flow generator.

In the jet mill device described above, it is also possible that a cross-section of the cavity chamber in the lower stage is hexagon or more polygon in shape, and that a cross-section of the cavity chamber in the upper stage is polygon less than hexagon in shape.

In the jet mill device described above, it is also possible that the cavity chamber in the upper stage comprises a plurality of small cavity chambers, and that the partition plate has a plurality of openings for leading the fine powder pulverized in the cavity chamber in the lower stage to the plurality of small cavity chambers in the upper stage.

In the jet mill device described above, it is also possible that a diamond electrodeposited layer is formed on the inner surface of the cavity chamber or a surface of the flat plate rotor.

The milling method according to one aspect of the present invention is characterized in that the milling method is the milling method for pulverizing a material to be pulverized into a fine powder by a jet mill device comprising a cavity chamber for pulverizing the material to be pulverized into the fine powder, an inner surface of the cavity chamber being formed of a material having a hardness higher than a hardness of the material to be pulverized, and an air flow generator for generating an air flow swirled in the cavity chamber, wherein the material to be pulverized fed into the cavity chamber is swirled by the air flow generated by the air flow generator and collides with the inner surface of the cavity chamber, whereby the material to be pulverized, thereby the material to be pulverized is pulverized into the fine powder.

In the milling method described above, it is also possible that the jet mill device further comprises a rotor body having a flat plate rotor rotating within the cavity chamber, a surface of the flat plate rotor being formed of a material having a higher hardness than that of the material to be pulverized, and that the material to be pulverized fed into the cavity chamber is swirled by the air flow generated by the air flow generator and collides the inner surface of the cavity chamber and the surface of the flat plate rotor, thereby the material to be pulverized is pulverized into the fine powder.

In the milling method described above, it is also possible that the rotor body of the jet mill device is formed by alternately stacking the flat plate rotor and a spacer, and a diameter of the spacer is smaller than a diameter of the flat plate rotor, and that the material to be pulverized fed into the cavity chamber is swirled by the air flow generated by the air flow generator and collides upper surfaces, outer surfaces and lower surfaces of the stacked flat plate rotors, thereby the material to be pulverized is pulverized into the fine powder.

In the milling method described above, it is also possible that a plurality of notches are formed on an outer circumference of the flat plate rotor of the rotor body of the jet mill device, and that the material to be pulverized fed into the cavity chamber is swirled by the air flow generated by the air flow generator and collides the plurality of notches on the outer circumference of the flat plate rotor, thereby the material to be pulverized is pulverized into the fine powder.

In the milling method described above, it is also possible that in the jet mill device, a plurality of stages of the cavity chamber and the air flow generator are stacked via a partition plate, and the partition plate has an opening for leading the fine powder pulverized in the cavity chambers in a lower stage to the cavity chambers in an upper stage, that the material to be pulverized is fed into the cavity chamber in the lower stage, that the material to be pulverized fed into the cavity chamber in the lower stage is swirled by the air flow generated by the air flow generator in the lower stage, the material to be pulverized collides with each other and the material to be pulverized collides the inner surface of the cavity chamber and a surface of the flat plate rotor, thereby the material to be pulverized is pulverized into the fine powder, that the fine powder pulverized in the cavity chamber in the lower stage is fed into the cavity chamber in the upper stage via the opening of the partition plate, and that the material to be pulverized fed into the cavity chamber in the upper stage is swirled by the air flow generated by the air flow generator in the upper stage, the material to be pulverized collides with each other and the material to be pulverized collides the inner surface of the cavity chamber, thereby the material to be pulverized is further pulverized into the fine powder.

In the milling method described above, it is also possible that in the jet mill device, the cavity chamber in the upper stage comprises a plurality of small cavity chambers, and the partition plate has a plurality of openings for leading the fine powder pulverized in the cavity chamber in the lower stage to the plurality of small cavity chambers in the upper stage, that the fine powder pulverized in the cavity chamber in the lower stage is fed into the plurality of small cavity chambers in the upper stage via the plurality of opening of the partition plate, and that the material to be pulverized fed into the plurality of small cavity chambers in the cavity chamber in the upper stage is swirled by the air flow generated by the air flow generator in the upper stage, the material to be pulverized collides with each other and the material to be pulverized collides the inner surface of the cavity chamber, thereby the material to be pulverized is further pulverized into the fine powder.

In the milling method described above, it is also possible that a diamond electrodeposited layer is formed on the inner surface of the cavity chamber or a surface of the flat plate rotor in the jet mill device, and that the material to be pulverized fed into the cavity chamber collides the diamond electrodeposited layer formed on the inner surface of the cavity chamber or a surface of the flat plate rotor, thereby the material to be pulverized is pulverized into the fine powder.

### Effects of the Invention

As described above, according to the present invention, a jet mill device comprises a cavity chamber for pulverizing a material to be pulverized into a fine powder, an inner surface of the cavity chamber being formed of a material having a hardness higher than a hardness of the material to be pulverized, and an air flow generator for generating an air flow swirled in the cavity chamber, wherein the material to be pulverized fed into the cavity chamber is swirled by the air flow generated by the air flow generator and collides with the inner surface of the cavity chamber, thereby the material to be pulverized is pulverized into the fine powder, so that even highly hard materials can be pulverized.

### BRIEF DESCRIPTION OF THE DRAWINGS

FIG. 1 shows a jet mill device according to a first embodiment of the present invention.

FIG. 2 shows a main part of the jet mill device according to the first embodiment of the present invention.

FIG. 3 shows a flat plate rotor of the jet mill device according to the first embodiment of the present invention.

FIG. 4 shows a spacer ring of the jet mill device according to the first embodiment of the present invention.

FIG. 5 shows an underplate of the jet mill device according to the first embodiment of the present invention.

FIG. 6 shows an under guide ring of the jet mill device according to the first embodiment of the present invention.

FIG. 7 shows a jet ring of the jet mill device according to the first embodiment of the present invention.

FIG. 8 shows a guide ring of the jet mill device according to the first embodiment of the present invention.

FIG. 9 shows a diamond electrodeposition plate of the jet mill device according to the first embodiment of the present invention.

FIG. 10 is a cross-sectional view of a flat plate rotor of a jet mill device according to a second embodiment of the present invention.

FIG. 11 is a cross-sectional view of a jet ring of the jet mill device according to the second embodiment of the present invention.

FIG. 12 is a cross-sectional view of a main part of the jet mill device according to the second embodiment of the present invention.

FIG. 13 shows a jet mill device according to a third embodiment of the present invention.

FIG. 14 shows a jet mill device according to a fourth embodiment of the present invention.

FIG. 15 shows a jet mill device according to a fifth embodiment of the present invention.

FIG. 16 shows a jet mill device according to a sixth embodiment of the present invention.

FIG. 17 shows a milling state of the jet mill device according to the sixth embodiment of the present invention.

FIG. 18 shows a jet mill device according to a seventh embodiment of the present invention.

FIG. 19 shows a jet mill device according to an eighth embodiment of the present invention.

FIG. 20 shows a first jet ring and a second jet ring of the jet mill device according to the eighth embodiment of the present invention.

FIG. 21 shows a first partition plate of the jet mill device according to the eighth embodiment of the present invention.

FIG. 22 shows a second partition plate of the jet mill device according to the eighth embodiment of the present invention.

FIG. 23 is a superimposed view of the second jet ring and the second partition plate of the jet mill device according to the eighth embodiment of the present invention.

FIG. 24 is a superimposed view of the first jet ring, the second jet ring, the first partition plate, and the second partition plate of the jet mill device according to the eighth embodiment of the present invention.

FIG. 25 shows a milling state of a material to be pulverized in the jet mill device according to the eighth embodiment of the present invention.

FIG. 26 shows a jet mill device according to a ninth embodiment of the present invention.

FIG. 27 shows a first jet ring and a second jet ring of the jet mill device according to the ninth embodiment of the present invention.

FIG. 28 shows a first partition plate of the jet mill device according to the ninth embodiment of the present invention.

FIG. 29 shows a second partition plate of the jet mill device according to the ninth embodiment of the present invention.

FIG. 30 shows a third partition plate of the jet mill device according to the ninth embodiment of the present invention.

FIG. 31 shows a fourth partition plate of the jet mill device according to the ninth embodiment of the present invention.

FIG. 32 shows a top plate of the jet mill device according to the ninth embodiment of the present invention.

FIG. 33 is a superimposed view of the first jet ring, the second jet ring, the first partition plate, the second partition plate, the third partition plate, and the fourth partition plate of the jet mill device according to the ninth embodiment of the present invention.

### MODE FOR CARRYING OUT THE INVENTION

### First Embodiment

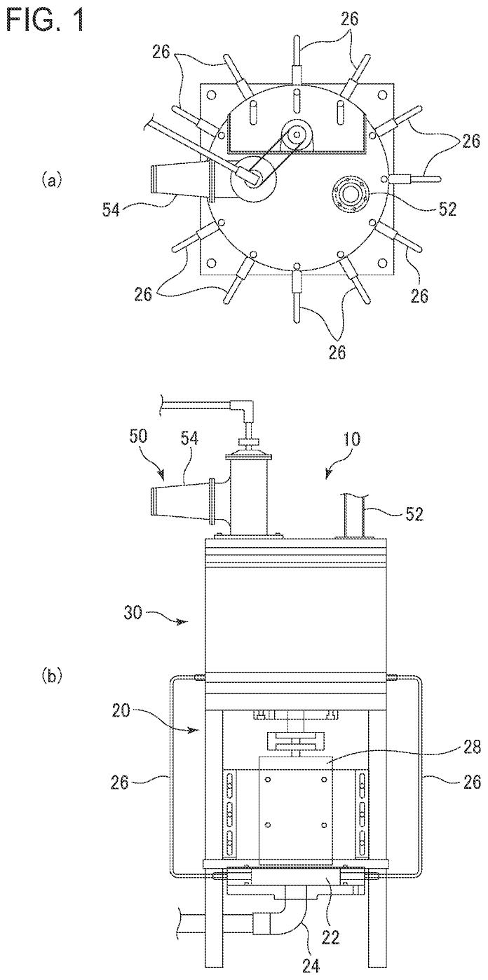

The jet mill device according to the first embodiment of the present invention will be described with reference to FIGS. 1 to 9.

### (Configuration of Jet Mill Device)

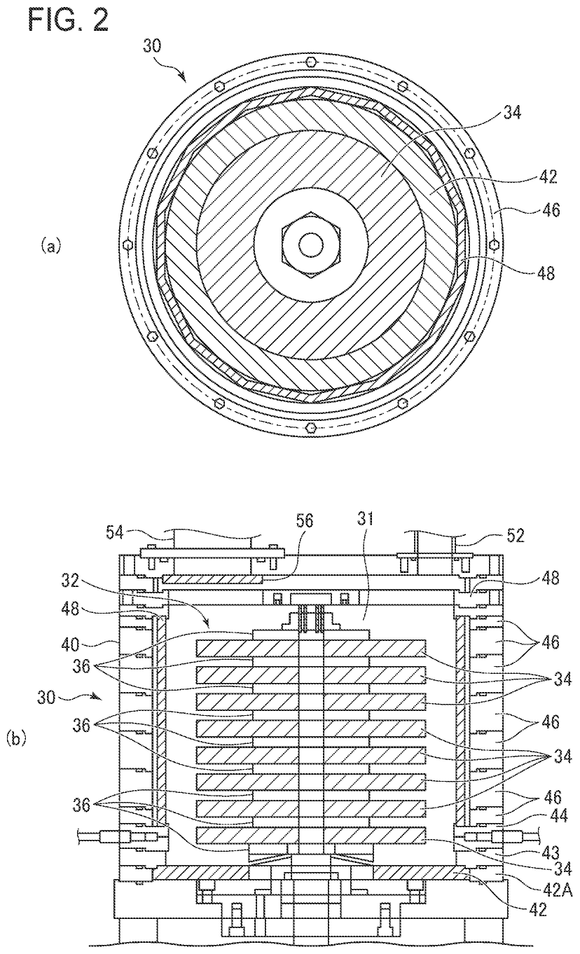

The configuration of the jet mill device according to the present embodiment is explained using FIG. 1 and FIG. 2. FIG. 1 shows an appearance of the jet mill device according to the present embodiment, in which FIG. 1(a) is a plan view of the jet mill device and FIG. 1(b) is a front view of the jet mill device. FIG. 2 shows a main part of the jet mill device according to the present embodiment, in which FIG. 2(a) is a cross-sectional view of the main part of the jet mill device, and FIG. 2(b) is a longitudinal cross-sectional view of the main part of the jet mill device.

The jet mill device 10 of the present embodiment comprises a rectangular shaped base section 20, a cylindrical shaped pulverizing section 30 formed on the base section 20 that pulverizes a material to be pulverized into fine powder, and an input/output section 50 formed on the pulverizing section 30 that inputs the material to be pulverized to the pulverizing section 30, and outputs the milled, or pulverized fine powder from the pulverizing section 30.

Within the pulverizing section 30, there is a cavity chamber 31 in which the material to be pulverized is processed for pulverization. The input/output section 50 feeds the material to be pulverized into the cavity chamber 31 of the pulverizing section 30 and retrieves the pulverized fine powder from the cavity chamber 31 of the pulverizing section 30.

### (Base Section)

The base section of the jet mill device according to the present embodiment is explained using FIG. 1(b).

At the bottom of the base section 20, a compressed air tank 22 is provided to feed compressed air into the cavity chamber 31 of the pulverizing section 30. A compressed air connection port 24 is formed at the lower center of the compressed air tank 22. A compressor (not shown) that generates compressed air is connected to the compressed air connection port 24. A plurality of compressed air feed pipes 26 that connect the compressed air tank 22 of the base section 20 to the cavity chamber 31 of the pulverizing section 30 are provided. In FIG. 1(b), the compressed air feed pipes 26 are not shown.

Compressed air generated by a compressor (not shown) is sent from the compressed air connection port 24 to the compressed air tank 22 and then sent by the compressed air feed pipes 26 to the cavity chamber 31 of the pulverizing section 30.

A drive motor for rotation 28 is provided at the top of the base section 20. The drive motor for rotation 28 rotates a flat plate rotor stack 32 in the pulverizing section 30 which will be described later.

### (Pulverizing Section: Flat Plate Rotor Stack (Rotor Unit))

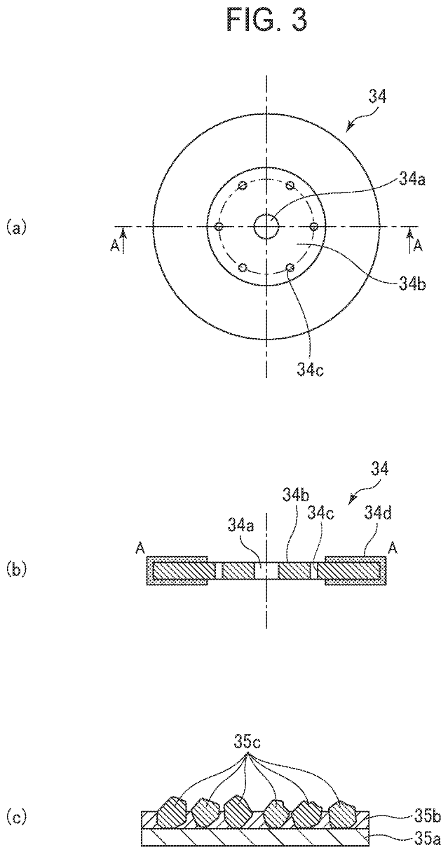

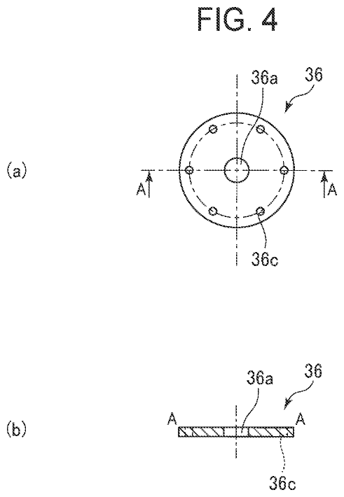

The flat plate rotor stack of the jet mill device according to the present embodiment is explained using FIG. 2, FIG. 3, and FIG. 4. FIG. 2 shows a main part of the jet mill device according to the present embodiment. FIG. 2(a) is a cross-sectional view of the main part of the jet mill device, and FIG. 2(b) is a longitudinal cross-sectional view of the main part of the jet mill device. FIG. 3 shows a flat plate rotor of the jet mill device according to the present embodiment, and FIG. 4 shows a spacer ring of the jet mill device according to the present embodiment.

A flat plate rotor stack 32 is provided in the center of the cavity chamber 31 of the pulverizing section 30. The flat plate rotor stack 32 is formed by alternately stacking flat plate rotors 34 and spacer rings 36. Thereby, a plurality of the flat plate rotor 34 are stacked at a predetermined interval, which is the thickness of the spacer ring 36.

The flat plate rotor 34 is shown in FIG. 3. FIG. 3(a) is a plan view of the flat plate rotor 34, and FIG. 3(b) is an A-A cross section of the flat plate rotor 34.

The flat plate rotor 34 is disc-shaped and has a through hole 34a in the center through which a rotation shaft of the drive motor for rotation 28 passes. The diameter of the flat plate rotor 34 is, for example, 240 mm. The thickness of the flat plate rotor 34 is, for example, 18 mm. The material of the flat plate rotor 34 is, for example, S45C (carbon steel). The diameter of the through hole 34a is, for example, 25 mm.

All areas of the flat plate rotor 34 except for the circular central area 34b where the spacer ring 36 contacts, are diamond electrodeposited, and a diamond electrodeposited layer 34d is formed on the surface of that area.

The diameter of the central area 34b is, for example, 125 mm. Six through holes 34c are formed in the central area 34b for stacking with the spacer ring 36. The diameter of the through holes 34c is, for example, 8 mm.

The flat plate rotor 34 is characterized in that all areas except for the central area 34b are processed by diamond electrodeposition to form a diamond electrodeposited layer 34d.

The diamond electrodeposition process is, for example, a process applied to diamond electrodeposition tools. For example, as shown in FIG. 3(c), diamond abrasive grains or CBN abrasive grains 35c are fixed to the plating layer 35b by electroplating on the base metal (base material) 35a. CBN is the second hardest substance after diamond, and is a compound made of cubic Boron Nitride including boron and nitrogen.

The base metal (base material) 35a of the flat plate rotor 34 in the present embodiment is, for example, S45C (carbon steel), and diamond abrasive grains or CBN abrasive grains 35c are fixed to the nickel plating layer 35b by, for example nickel plating. The thickness of the nickel plating layer 35b is, for example, 50 μm, and the grain diameter of the diamond abrasive grains or CBN abrasive grains 35c is, for example, 100 μm. The density of the diamond abrasive grains or CBN abrasive grains 35c is, for example, 100 grains/mm².

The diamond electrodeposited layer 34d consists of a plating layer 35b and diamond abrasive grains or CBN abrasive grains 35c as shown in FIG. 3(c).

The spacer ring 36 is shown in FIG. 4. FIG. 4(a) is a plan view of the spacer ring 36, and FIG. 4(b) is an A-A cross section of the spacer ring 36.

The spacer ring 36 is disk-shaped and has a through hole 36a in the center through which the rotary shaft of the drive motor for rotation 28 passes. The diameter of the spacer ring 36 is, for example, 120 mm. The thickness of the spacer ring 36 is, for example, 10 mm. The material of the spacer ring 36 is, for example, SUS316 (stainless steel). The diameter of the through hole 36a is, for example, 25 mm.

The spacer ring 36 has six through holes 36c for stacking in the central area 34b of the flat plate rotor 34. The diameter of the through holes 36c is, for example, 8 mm.

The flat plate rotor 34 shown in FIG. 3 and the spacer ring 36 shown in FIG. 4 are alternately stacked to form the flat plate rotor stack 32. The six through holes 34c of the flat plate rotor 34 and the six through holes 36c of the spacer ring 36 are aligned, rods (not shown) are passed through the aligned six through holes 34c and 36c, respectively, and the rods (not shown) are tightened from the upper end and lower end to form the solid flat plate rotor stack 32.

In the present embodiment, for example, as shown in FIG. 2(b), eight flat plate rotors 34 and nine spacer rings 36 are alternately stacked to form the flat plate rotor stack 32.

The rotary shaft of the drive motor for rotation 28 is passed through the through holes 34a and 36a of the flat plate rotor stack 32, and the flat plate rotor stack 32 is placed in the cavity chamber 31 of the pulverizing section 30, as shown in FIG. 2(b).

### (Pulverizing Section: Fixed Ring Stack (Air Flow Generator))

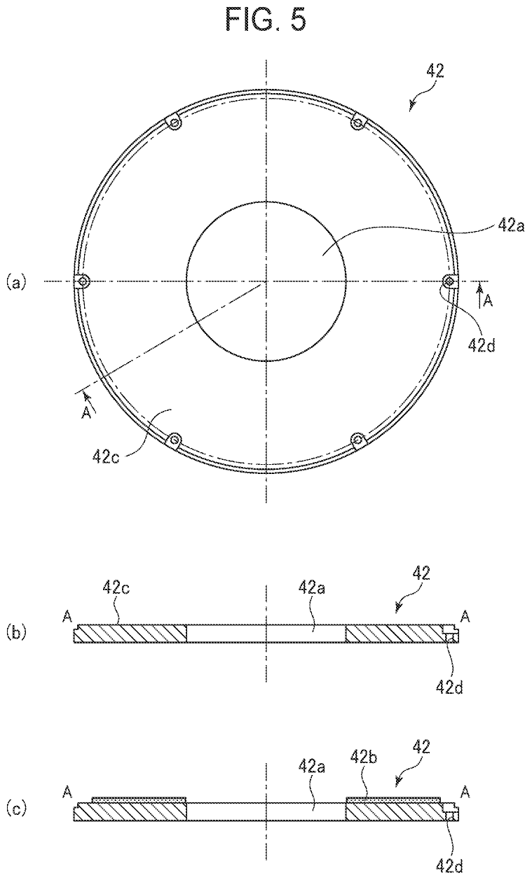

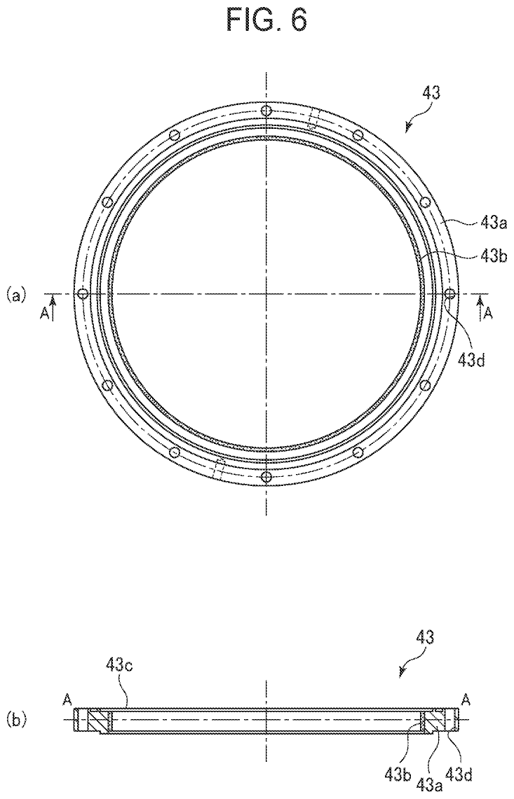

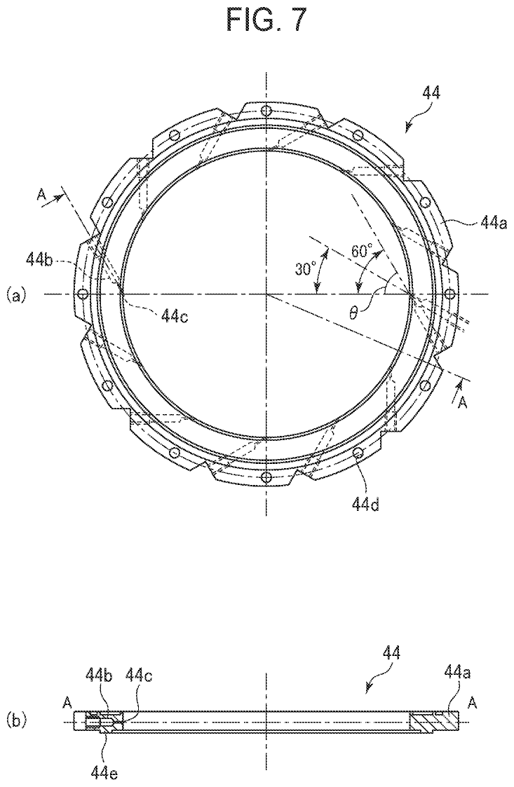

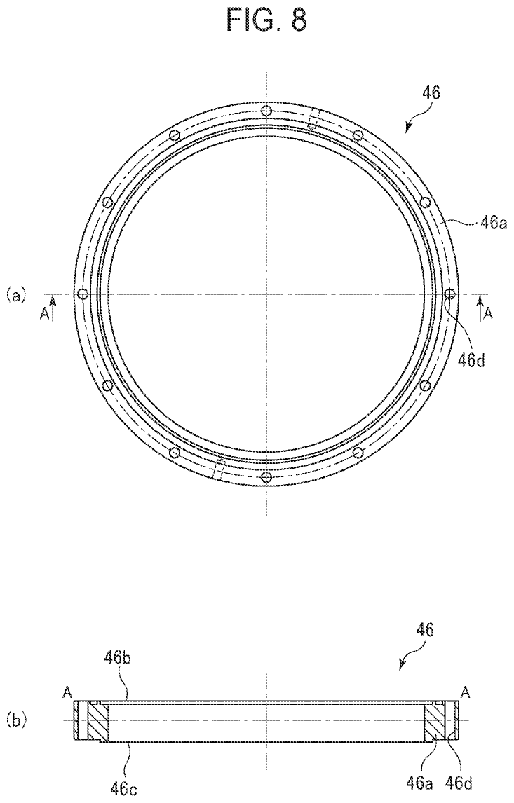

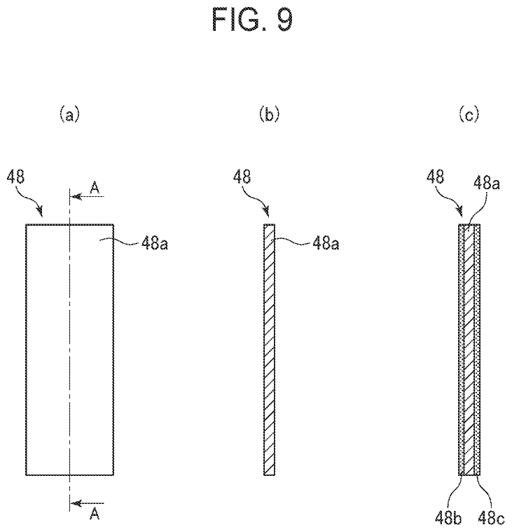

A fixed ring stack of the jet mill device according to the present embodiment is explained using FIG. 5, FIG. 6, FIG. 7, FIG. 8, and FIG. 9. FIG. 5 shows an underplate of the jet mill device according to the present embodiment of the present invention. FIG. 6 shows an under guide ring of the jet mill device according to the present embodiment of the present invention. FIG. 7 shows a jet ring of the jet mill device according to the present embodiment of the present invention. FIG. 8 shows a guide ring of the jet mill device according to the present embodiment of the present invention. FIG. 9 shows a diamond electrodeposition plate of the jet mill device according to the present embodiment of the present invention.

A fixed ring stack 40 is provided around the flat plate rotor stack 32 in the center of the cavity chamber 31 of the pulverizing section 30. The fixed ring stack 40 defines the cavity chamber 31, which is a pulverizing space for pulverizing the material to be pulverized.

The fixed ring stack 40 comprises an underplate guide ring 42A surrounding an underplate 42 provided at the bottom of the cavity chamber 31 of the pulverizing section 30, an under guide ring 43 provided on the underplate guide ring 42A, a jet ring 44 provided on the under guide ring 43 and a guide ring 46 stacked on the jet ring 44. A plurality of diamond electrodeposition plates 48 are laid on the side wall of the cavity chamber 31 formed by the under guide ring 43, jet ring 44 and guide ring 46.

The underplate 42 is shown in FIG. 5. FIG. 5(a) is a plan view of the underplate 42, and FIG. 5(b) and FIG. 5(c) are A-A cross sections of the underplate 42.

The bottom of the cavity chamber 31 of the pulverizing section 30 is composed of two parts (underplate 42 and underplate guide ring 42A), wherein the outer circumference of the underplate 42 is surrounded by the underplate guide ring 42A. By making the underplate 42 interchangeable, the diamond grain size of the bottom of the cavity chamber 31 can be easily changed.

The underplate 42 is a circular plate formed an opening 42a in a central thereof. An area 42c outside of the opening 42a of the underplate 42 is subjected to diamond electrodeposition, and a diamond electrodeposited layer 42b is formed on the surface of the area 42c, as shown in FIG. 5(c). Six screw holes 42d are formed in the outermost area of the underplate 42.

The diamond electrodeposition process is, for example, a process applied to diamond electroplated tools, as explained using FIG. 3(c). The diamond electrodeposited layer 42b also consists of a plating layer 35b and diamond abrasive grains or CBN abrasive grains 35c as shown in FIG. 3(c).

The under guide ring 43 is shown in FIG. 6. FIG. 6(a) is a plan view of the under guide ring 43 and FIG. 6(b) is an A-A cross section of the under guide ring 43.

The under guide ring 43 comprises a doughnut-shaped under guide ring body 43a. An inner surface of the under guide ring body 43a is diamond electrodeposited to form a diamond electrodeposited layer 43b on the inner surface. Six through holes 43d are formed in an outermost area of the under guide ring 43.

The diamond electrodeposition process is, for example, a process applied to diamond electroplated tools, as explained using FIG. 3(c). The diamond electrodeposited layer 43b also consists of a plating layer 35b and diamond abrasive grains or CBN abrasive grains 35c as shown in FIG. 3(c).

In order to fit and stack the jet ring 44 in the correct position when stacking the jet ring 44 on the under guide ring 43, a concave portion 43c is formed on the top surface of the under guide ring body 43a.

A plurality of through holes 43d for stacking the doughnut-shaped jet ring 44 under guide ring body 43a are formed in the under guide ring 43.

The jet ring 44 is shown in FIG. 7. FIG. 7(a) is a plan view of the jet ring 44, and FIG. 7(b) is an A-A cross section of the jet ring 44.

The jet ring 44 comprises a doughnut-shaped jet ring body 44a in which a plurality of jet nozzles 44b are provided. For example, in FIG. 7(a), 12 jet nozzles 44b are provided at intervals of about 30 degrees. The plurality of jet nozzles 44b generate a swirling air flow in the cavity chamber 31.

A jet opening 44c, for example, with a diameter of 1.0 mm and a length of 20.0 mm is formed in the jet nozzle 44b. The jet opening 44c of the jet nozzle 44b is inclined to the right by, for example, 30 degrees from a straight line passing through the center of the jet ring body 44a. The air jetted from the jet opening 44c of the jet nozzle 44b generates a counterclockwise swirling flow in the cavity chamber 31.

The inclination of the jet opening 44c of the jet nozzle 44b may be within an angle θ of about 30 degrees to about 60 degrees when indicated by an angle θ from a straight line passing through the center of the jet ring body 44a. FIG. 7(a) shows the case where the angle θ of inclination of the jet opening 44c of all of the jet nozzles 44b is 60 degrees. In case that the angle θ of inclination of the jet opening 44c of the jet nozzle 44b is 30 degrees, the inclination is as shown by the rightmost jet nozzle 44b in FIG. 7(a).

In order to fit and stack the jet ring 44 in the correct position when stacking, a convex portion 44e is formed on the bottom surface of the jet ring body 44a. When stacking, the convex portion 44e of the jet ring 44 located above mates with the concave portion 43c of the under guide ring 43 located below.

In the jet ring 44, a plurality of through holes 44d are formed in the doughnut-shaped jet ring body 44a for stacking the guide ring 46.

The guide ring 46 is shown in FIG. 8. FIG. 8(a) is a plan view of the guide ring 46, and FIG. 8(b) is an A-A cross section view of the guide ring 46.

The guide ring 46 comprises a doughnut-shaped guide ring body 46a. In order to fit and stack the guide ring 46 in the correct position when stacking, a concave portion 46b is formed on the top surface of the guide ring body 46a and a convex portion 46c is formed on the bottom surface. When stacking, the convex portion 46c of the guide ring 46 located above mates with the concave portion 46b of the guide ring 46 located below.

In the guide ring 46, a plurality of through holes 46d are formed in the doughnut-shaped guide ring body 46a for stacking the guide rings 46.

In order to form the fixed ring stack 40, an under guide ring 43 is stacked on the underplate guide ring 42A surrounding the underplate 42, the jet ring 44 is stacked on the under guide ring 43, the guide ring 46 is stacked on the jet ring 44, the guide ring 46 is stacked on the guide ring 46, and repeat this process to stack a plurality of guide rings 46.

In this way, the under guide ring 43, the jet ring 44 and the plurality of guide rings 46 form the cavity chamber 31.

In the present embodiment, the entire sidewall of the cavity chamber 31 thus formed is covered with diamond electrodeposition plates 48 like tiles.

The diamond electrodeposition plate 48 comprises a rectangular plate body 48a. The plate body 48a is, for example, rectangular in shape, 70 mm wide and 200 mm long, and 8 mm thick.

As shown in FIG. 9(c), diamond electrodeposition is applied to both sides of the diamond electrodeposition plate 48. In the present embodiment, diamond electrodeposition processing of different grain sizes is applied to both sides of the diamond electrodeposition plate 48 to form the diamond electrodeposited layer 48b and the diamond electrodeposited layer 48c.

The diamond electrodeposition process is, for example, a process applied to diamond electrodeposition tools, as explained using FIG. 3(c). The diamond electrodeposited layer 48b and the diamond electrodeposited layer 48c also consist of a plating layer 35b and diamond abrasive grains or CBN abrasive grains 35c as shown in FIG. 3(c).

In the diamond electrodeposited layer 48b on one side of the diamond electrodeposition plate 48, the thickness of the nickel plating layer 35b is, for example, 50 μm, and the grain size of the diamond abrasive grain or CBN abrasive grain 35c is, for example, 100 μm. The density of the diamond grains or CBN grains 35c is, for example, 100 grains/mm².

In the diamond electrodeposited layer 48c on the other side of the diamond electrodeposition plate 48, the thickness of the nickel plating layer 35b is, for example, 25 μm, and the grain diameter of the diamond grains or CBN grains 35c is, for example, 50 μm. The density of diamond or CBN abrasive grains 35c is, for example, 400 grains/mm².

In the present embodiment, the entire sidewall of the cavity chamber 31 is covered with diamond electrodeposition plate 48 like tiles, but the diamond electrodeposition plate 48 is not used, and the inner wall surface of the guide ring 46 may be processed with a diamond electrodeposited layer.

### (Input/Output Section)

The input/output section 50 of the jet mill device according to the present embodiment is described using FIG. 1 and FIG. 2.

As shown in FIG. 1, the input/output section 50 is provided on the pulverizing section 30, which inputs the material to be pulverized into the cavity chamber 31 of the pulverizing section 30 and outputs the pulverized fine powder from the cavity chamber 31 of the pulverizing section 30.

The input/output section 50 is provided with a material input pipe 52 for inputting the material to be pulverized into the cavity chamber 31 of the pulverizing section 30 and a fine powder outlet 54 for discharging the pulverized fine powder.

A mesh section 56 is provided at the connection port of the fine powder outlet 54 with the cavity chamber 31 of the pulverizing section 30. The mesh section 56 is formed to a predetermined density. This allows fine powder that has been pulverized to a finer particle size than the predetermined density to be taken out to the outside.

### (Operation of Jet Mill Device)

The operation of the jet mill device according to the present embodiment is described below.

First, a compressor (not shown) that generates compressed air is activated and compressed air from the compressed air tank 22 is fed through the compressed air connection port 24. The compressed air is sent to the pulverizing section 30 via the compressed air feed pipes 26, and is jetted out from a plurality of jet nozzles 44b provided in the jet ring 44, which constitutes the fixed ring stack 40, to generate a swirling air flow in the cavity chamber 31.

At the same time, the drive motor for rotation 28 of the base section 20 is driven to rotate the flat plate rotor stack 32 in the pulverizing section 30 at high speed. The direction of rotation of the flat plate rotor stack 32 is the same as the direction of rotation of the air flow swirling in the cavity chamber 31 by the plurality of jet nozzles 44b.

The direction of rotation of the flat plate rotor stack 32 is the same as the swirling direction of the air flow swirling in the cavity chamber 31 for the following reasons. First, the velocity of the swirling flow is amplified by setting them in the same direction. Second, the same direction increases the impact on the diamond. Third, since the velocity of the swirling flow is amplified, the material to be pulverized (particles) efficiently contacts the diamond electrodeposited layer. Fourth, the same direction of the swirling flow facilitates the downward movement of particles with larger diameters and the upward movement of particles with smaller diameters.

Next, material to be pulverized is fed into the cavity chamber 31 of the pulverizing section 30 from the material input pipe 52 of the input/output section 50. The fed material to be pulverize swirls in the cavity chamber 31 on the swirling flow formed in the cavity chamber 31. The swirling material to be pulverized is pulverized into fine powder by impacting the underplate 42, the under guide ring 43, and the diamond electrodeposition plate 48 on the side wall of the cavity chamber 31, by impacting the flat plate rotor 34 of the flat plate rotor stack 32, or by colliding with other material to be pulverized.

Even if the material to be pulverized is highly hard, the flat plate rotor stack 32 is made up of flat plate rotors 34 and the diamond electrodeposited layer 34d is formed in the area other than the central area 34b of the flat plate rotor 34, thereby the flat plate rotor 34 is not destroyed even if the material to be pulverized collides with them.

In addition, the diamond electrodeposited layer 42b is formed on the surface of the area 42c of the underplate 42, where the crushed material impacts, the diamond electrodeposited layer 43b is formed on the inner surface of the under guide ring body 43a, where the material to be pulverized impacts, the diamond electrodeposited layer 48b or 48c is formed on the surface of diamond electrodeposited layer 48b or 48c, where the material to be pulverized impacts, and the diamond electrodeposited layer 34d is formed in the area other than the central area 34b of flat plate rotor 34, where the material to be pulverized impacts, whereby, even if the material to be pulverized impacts them, the diamond electrodeposited layers 42b, 43b, 48b, and 48c are not scraped off and mixed into the product fine powder.

The pulverized fine powder swirls at high speed in the cavity chamber 31 on the swirling current and rises in the cavity chamber 31 like a tornado. Of the fine powder that swirls and rises, the fine powder with a particle size finer than the density of the mesh section 56 provided at the connection port with the cavity chamber 31 passes through the mesh section 56 and is discharged outside through the fine powder outlet 54 to be collected as the fine powder of product.

Thus, according to the present embodiment, the jet mill device with excellent wear resistance to powder can be realized.

### Second Embodiment

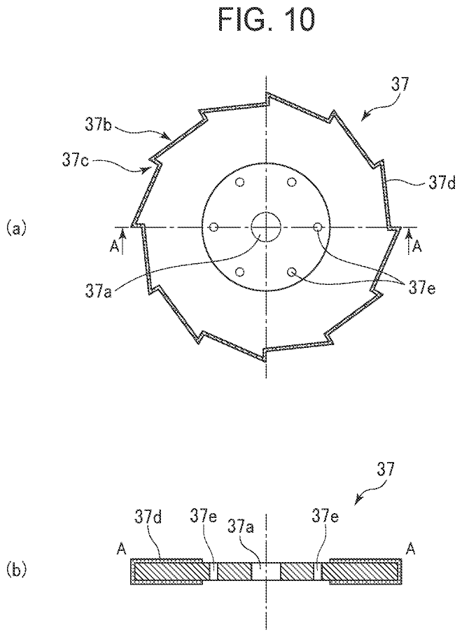

The jet mill device according to the second embodiment of the present invention will be described using FIGS. 10 to 12.

The jet mill device of the present embodiment has an improved rotor and jet ring in the jet mill device according to the first embodiment of the present invention. The other configuration is the same as that of the jet mill device according to the first embodiment of the present invention.

### (Pulverizing Section: Rotor (Rotor Body))

The rotor of the jet mill device according to the present embodiment is described using FIG. 10.

FIG. 10 shows the flat plate rotors 37 to form the rotor of the present embodiment. FIG. 10(a) is a plan view of the flat plate rotor 37, and FIG. 10(b) is an A-A cross section of the flat plate rotor 37.

The flat plate rotor 37 is almost circular in shape and has a through hole 37a in the center through which the rotary shaft of the drive motor for rotation 28 passes, and around it are six through holes 37e for attaching a spacer ring 36 as shown in FIG. 4. The flat plate rotor 37 and the spacer ring 36 are alternately stacked to form a flat plate rotor stack 38 similar to the flat plate rotor stack 32.

The flat plate rotor 37 of the present embodiment is characterized in that a notch is formed on the outer circumference. The outer circumference of the flat plate rotor 37 is alternately formed with a flat portion 37b and a notch portion 37c, and notches are formed at 12 locations throughout the outer circumference, giving a cross section a shuriken-like shape. The depth of the notch portion 37c is, for example, 10 mm.

A diamond electrodeposited layer 37d is formed on the surface of the flat portions 37b and the notch portions 37c. The diamond electrodeposited layer 37d consists of a plating layer 35b and diamond abrasive grains or CBN abrasive grains 35c as shown in FIG. 3(c).

The diamond electrodeposited layer 37d is formed on the entire outer circumference of the flat plate rotor stack 38, which is made by stacking the flat plate rotors 37, thereby improving wear resistance. When the flat plate rotor stack 38 rotates at high speed, the notch portions 37c formed on the outer circumference of each of the flat plate rotors 37 of the flat plate rotor stack 38 amplify the velocity of the swirling flow in the cavity chamber 31 of the pulverizing section 30. The material to be pulverized, which is swirled by the swirling flow, impacts the notch portions 37c of each of the flat plate rotors 37 of the flat plate rotor stack 38, and is also crushed by the impact.

Instead of the flat plate rotor stack 38, which consists of alternating layers of the flat plate rotors 37 and the spacer rings 36, the flat plate rotor stack 38 may be cylindrical as a whole, with notches formed on its outer circumference.

### (Pulverizing Section: Jet Ring (Air Flow Generator))

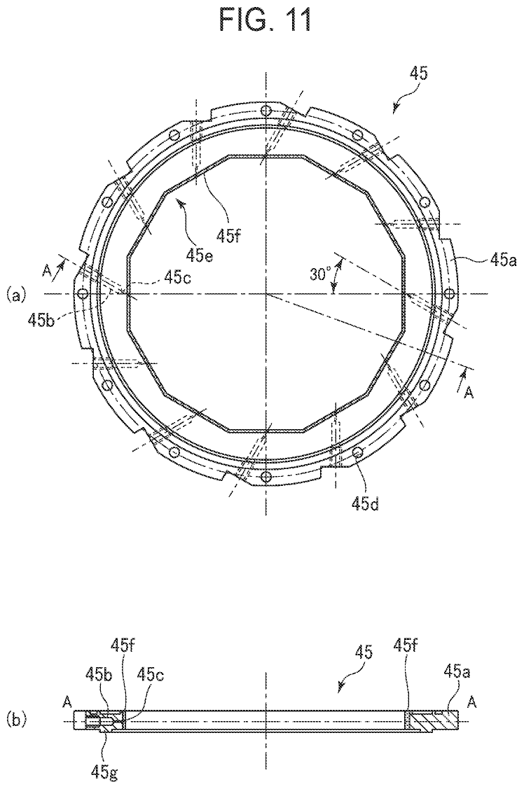

The jet ring of the jet mill device according to the present embodiment is explained using FIG. 11. FIG. 11 shows a cross-sectional view of the jet ring of the jet mill device according to the present embodiment.

As shown in FIG. 11, the jet ring 45 of the present embodiment is characterized by the fact that its inner surface is not circular, but dodecahedral in shape, for example.

The jet ring 45 is shown in FIG. 11. FIG. 11(a) is a plan view of the jet ring 45, and FIG. 11(b) is an A-A cross section of the jet ring 45.

The jet ring 45 has a doughnut-shaped jet ring body 45a with a plurality of jet nozzles 45b. For example, in FIG. 11(a), the 12 jet nozzles 45b are provided at intervals of about 30 degrees. The plurality of jet nozzles 45b generate a swirling air flow in the cavity chamber 31.

The jet nozzles 45b, for example, have a diameter of 1.0 mm and a length of 20.0 mm. The jet nozzle 45b is inclined to the right by, for example, 30 degrees from a straight line passing through the center of the jet ring body 45a. The air jetted from the jet opening 45c of the jet nozzle 45b generates a counterclockwise swirling flow in the cavity chamber 31.

The inclination of the jet opening 45c of the jet nozzle 45b may be within the range of about 30 to 60 degrees when the angle θ is shown as an angle θ from a straight line passing through the center of the jet ring body 45a. FIG. 11(a) shows the case where the angle θ of inclination of the jet opening 45c of all the jet nozzles 45b is 30 degrees.

In order to fit and stack the jet ring 45 in the correct position when stacking, a convex portion 45g is formed on the bottom surface of the jet ring body 45a. When stacking, the convex portion 45g of the jet ring 45 located above mates with the concave portion 43c of the under guide ring 43 located below.

In the jet ring 45, a plurality of through holes 45d are formed in the doughnut-shaped jet ring body 45a for stacking the guide ring 46.

The jet ring 45 of the present embodiment has a dodecahedral shape with its inner surface consisting of 12 flat portions 45e. A diamond electrodeposited layer 45f is formed on the surface of the flat portions 45e of the jet ring 45. The diamond electrodeposited layer 45f consists of a plating layer 35b and diamond abrasive grains or CBN abrasive grains 35c as shown in FIG. 3(c).

The diamond electrodeposited layer 45f is formed on the entire inner surface of the jet ring 45, which improves wear resistance. The material to be pulverized, which is swirled by the swirling flow in the cavity chamber 31 of the pulverizing section 30, collides with the dodecahedron on the inner surface of the jet ring 45 and is also pulverized by the impact of the swirling flow.

### (Operation of Jet Mill Device)

The operation of the jet mill device according to the present embodiment is described below.

First, a compressor (not shown) that generates compressed air is activated, and compressed air is jetted out from a plurality of the jet nozzles 45b in the jet ring 45 to generate a swirling air flow in the cavity chamber 31.

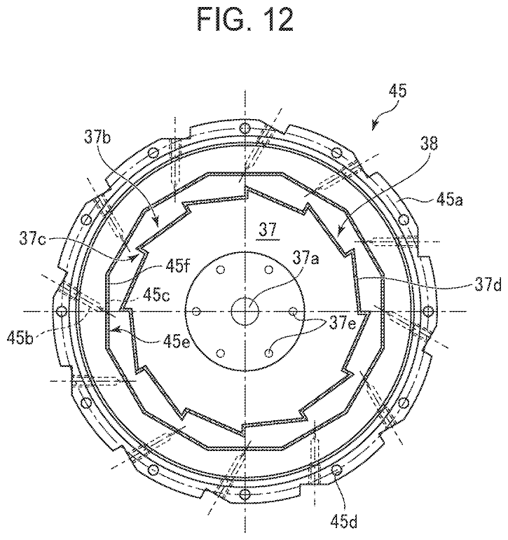

The main part of the jet mill device according to the present embodiment is shown in FIG. 12. The flat plate rotor stack 38, in which the flat plate rotors 37 shown in FIG. 10 are stacked, is housed in the cavity chamber 31 in the jet ring 45 shown in FIG. 11.

The drive motor for rotation 28 in the base section 20 is driven to rotate the flat plate rotor stack 38 in the cavity chamber 31 of the pulverizing section 30 at high speed. The direction of rotation of the flat plate rotor stack 38 is the same as the direction of rotation of the air flow swirling in the cavity chamber 31 by the plurality of jet nozzles 45b of the jet ring 45.

The rotation direction of the flat plate rotor stack 38 is the same as the swirling direction of the air flow swirling in the cavity chamber 31 for the following reasons. First, the velocity of the swirling flow is amplified by setting them in the same direction. Second, the same direction increases the impact on the diamond. Third, since the velocity of the swirling flow is amplified, the material to be pulverized (particles) efficiently contacts the diamond electrodeposited layer. Fourth, the same direction of the swirling flow facilitates the downward movement of particles with larger diameters and the upward movement of particles with smaller diameters.

The straight air jetted from the jet opening 45c of the jet nozzle 45b of the jet ring 45 attracts the material to be pulverized and impacts the flat portion 37b of the flat plate rotor stack 38. Since the flat plate rotor stack 38 rotates, the angle of impact of the straight air on the flat portion 37b is constantly changing. Therefore, the direction of the air reflected by the flat portion 37b of the flat plate rotor stack 38 also changes constantly and impacts the dodecahedral flat portions 45e of the jet ring 45. As a result, the material to be pulverized carried by the air is efficiently pulverized.

Thus, according to the present embodiment, the jet mill device with excellent wear resistance due to powder can be realized.

### Third Embodiment

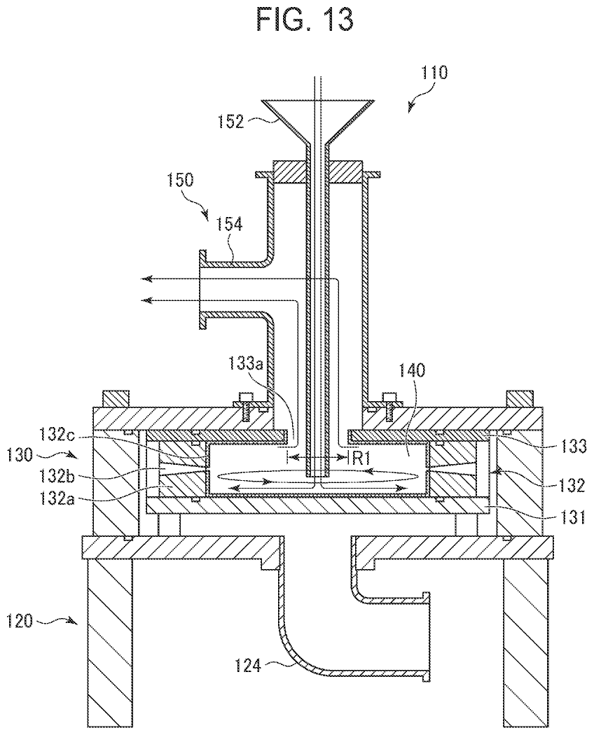

The jet mill device according to the third embodiment of the present invention is described using FIG. 13. FIG. 13 shows a longitudinal cross-sectional view of the jet mill device 110 of the present embodiment.

### (Configuration of Jet Mill Device)

The jet mill device 110 of the present embodiment consists of a base section 120, a cylindrical pulverizing section 130 provided on the base section 120 that pulverizes the material to be pulverized into fine powder, and an input/output section 150 provided on the pulverizing section 130 that inputs the material to be pulverized to the pulverizing section 130 and outputs the pulverized fine powder from the pulverizing section 130.

Within the pulverizing section 130, there is a cavity chamber 140 in which the material to be pulverized is processed. The input/output section 150 feeds the material to be pulverized into the cavity chamber 140 of the pulverizing section 130 and retrieves the pulverized fine powder from the cavity chamber 140 of the pulverizing section 130.

### (Base Section)

A compressed air tank (not shown) is provided in the base section 120 of the jet mill device according to the present embodiment, which feeds compressed air into the cavity chamber 140 of the pulverizing section 130. The compressed air tank (not shown) has a compressed air connection port 124. A compressor (not shown) that generates compressed air is connected to the compressed air connection port 124.

Compressed air generated by the compressor (not shown) is sent from the compressed air connection port 124 to the pulverizing section 130.

### (Pulverizing Section (Air Flow Generator))

The pulverizing section 130 of the jet mill device according to the present embodiment comprises an underplate 131 provided at the bottom of the cavity chamber 140, a jet ring 132 provided on the underplate 131, and a partition plate 133 provided on the jet ring 132.

The jet ring 132 is similar in configuration to the jet ring 44 of the first embodiment shown in FIG. 7. The jet ring 132 has a doughnut-shaped jet ring body 132a and a plurality of jet nozzles 132b. For example, in FIG. 7(a), the 12 jet nozzles 132b are provided at approximately 30 degree intervals. The plurality of jet nozzles 132b generate a swirling air flow in the cavity chamber 140.

The shape and arrangement of the jet nozzles 132b are similar to the configuration of the jet nozzles 44b of the jet ring 44 of the first embodiment shown in FIG. 7.

The jet ring 132 is sandwiched between an underplate 131 and a partition plate 133 to form a cavity chamber 140 in the pulverizing section 130.

The partition plate 133 has an opening 133a in the center. The diameter of the opening 133a is R1. Through the opening 133a of diameter R1 in the partition plate 133, a material to be pulverized is input from the input/output section 150 to the pulverizing section 130, and a pulverized fine powder is output from the pulverizing section 130 to the input/output section 150.

All areas of the inner surface of the cavity chamber the pulverizing section 130 are diamond 140 of electrodeposited, and a diamond electrodeposited layer 132c is formed on the surface of the area.

### (Input/Output Section)

As shown in FIG. 13, the input/output section 150 is provided on the pulverizing section 130 to input the material to be pulverized into the cavity chamber 140 of the pulverizing section 130 and to output the pulverized fine powder from the cavity chamber 140 of the pulverizing section 130.

The input/output section 150 is provided with a material input pipe 152 for inputting the material to be pulverized into the cavity chamber 140 of the pulverizing section 130 and a fine powder outlet 154 for discharging the pulverized fine powder. The material input pipe 152 passes through the opening 133a in the center of the partition plate 133 of the pulverizing section 130, and its lower end reaches into the cavity chamber 140.

The connection port between the input/output section 150 and the cavity chamber 140 is not provided with a mesh to allow only fine particles finer than a predetermined particle size to pass through, but the opening 133a of diameter R1 in the center of the partition plate 133 serves such function.

When the pulverized fine powder in the cavity chamber 140 of the pulverizing section 130 is swirled at high speed by the swirling air flow, the particle size distribution of the fine powder in the cavity chamber 140 is fine in the center and coarse in the surrounding area, i.e., the particle diameter of the fine powder in the center is small and that of the surrounding fine powder is large.

Since fine powder is output from the cavity chamber 140 to the input/output section 150 through the opening 133a of diameter R1 in the center of the partition plate 133, based on the particle size distribution of the fine powder in the cavity chamber 140, only fine particles within the opening 133a of diameter R1, that is, fine particles of small particle size The fine powder is discharged out of the fine powder outlet 54 and collected as fine powder as a product.

### (Operation of Jet Mill Device)

This section describes the operation of the Jet mill device in the present embodiment.

First, a compressor (not shown) that generates compressed air is activated and compressed air from a compressed air tank (not shown) is fed through the compressed air connection port 124. The compressed air is sent to the pulverizing section 130 and is ejected from a plurality of jet nozzles 132b in the jet ring 132 to generate a swirling air flow in the cavity chamber 140.

Next, material to be pulverized is fed into the cavity chamber 140 of the pulverizing section 130 from the material input pipe 152 of the input/output section 150. The material is then fed into the cavity chamber 140 of the pulverizing section 130 from the material input pipe 152 of the input/output section 150. The swirling material is pulverized into fine powder by colliding with the diamond electrodeposited layer 132c formed on the inner surface of the cavity chamber 140 of the pulverizing section 130, or by colliding with other material to be pulverized.

Since the diamond electrodeposited layer 132c is formed on the inner surface of the cavity chamber 140 where the material to be pulverized collide, t the diamond electrodeposited layer 132c is not scraped off and mixed into the product fine powder even if the material to be pulverized collide with each other.

The pulverized fine powder swirls at high speed in the cavity chamber 140 on the swirling flow and rises in the cavity chamber 140. The fine powder that swirls and rises passes through opening 133a in the center of partition plate 133 and is discharged outside through fine powder outlet 154 to be collected as fine powder as a product.

Thus, according to the present example, the jet mill device with excellent wear resistance due to powder can be realized.

### Fourth Embodiment

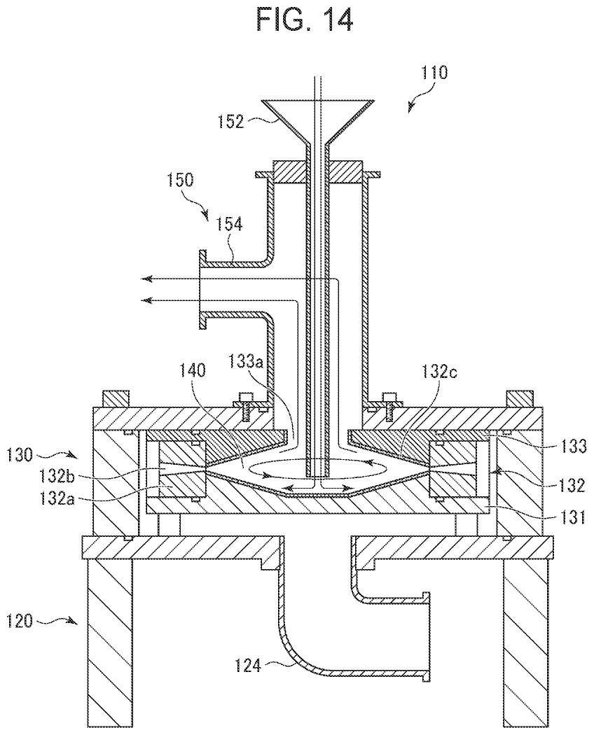

The jet mill device according to a variant embodiment of the fourth embodiment of the present invention is described using FIG. 14. The jet mill device of the present embodiment has an improved shape of the cavity chamber of the pulverizing section in the jet mill device of the third embodiment of the invention. The other configuration is the same as that of the jet mill device of the third embodiment of the invention.

### (Configuration of Jet Mill Device)

The jet mill device 110 of the present embodiment comprises a base section 120, a cylindrical pulverizing section 130 provided on the base section 120 that pulverizes the material to be pulverized into fine powder, and an input/output section 150 provided on the pulverizing section 130 that inputs the material to be pulverized to the pulverizing section 130 and outputs the pulverized fine powder from the pulverizing section 130.

Within the pulverizing section 130, there is a cavity chamber 140 in which the material to be pulverized is processed. The input/output section 150 feeds the material to be pulverized into the cavity chamber 140 of the pulverizing section 130 and retrieves the pulverized fine powder from the cavity chamber 140 of the pulverizing section 130.

### (Pulverizing Section (Air Flow Generator))

The pulverizing section 130 of the jet mill device according to the present embodiment consists 4 an underplate 131 provided at the bottom, a jet ring 132 provided on the underplate 131, and a partition plate 133 provided on the jet ring 132.

The top surface of the underplate 131 in the present embodiment is not flat, but has a mortar shape that is lowest in the center and higher around the periphery away from the center, as shown in FIG. 14. The lower surface of the partition plate 133 is not flat, but has a reverse mortar shape, symmetrical to the upper surface of the underplate 131, with the center being the lowest and the periphery moving away from the center being higher, as shown in FIG. 14.

Therefore, the cavity chamber 140 of the pulverizing section 130 defined by the upper surface of the underplate 131 and the lower surface of the partition plate 133 has a so-called abacus ball shape, which is thicker in the center and thinner at the periphery, as shown in FIG. 14.

The position of the thinnest part of the abacus ball-shaped cavity chamber 140 and the position of the plurality of jet nozzles 132b in the jet ring 132 are configured to match. Air from the plurality of jet nozzles 132b is injected into the so-called abacus ball-shaped cavity chamber 140. The plurality of jet nozzles 132b form a swirling air flow in the cavity chamber 140.

In the present embodiment, as shown in FIG. 14, diamond electrodeposition is applied to all areas of the inner surface of the cavity chamber 140 of the pulverizing section 130, and a diamond electrodeposited layer 132c is formed on the surface of those areas.

### (Operation of Jet Mill Device)

The operation of the jet milling apparatus according to the present embodiment will be described.

First, a compressor (not shown) that generates compressed air is activated and compressed air from a compressed air tank (not shown) is fed through the compressed air connection port 124. The compressed air is sent to the pulverizing section 130 and is jetted out from a plurality of jet nozzles 132b in the jet ring 132 to generate a swirling air flow in the abacus ball-shaped cavity chamber 140.

Next, material to be pulverized is fed into the cavity chamber 140 of the pulverizing section 130 from the material input pipe 152 of the input/output section 150. The fed material to be pulverize swirls in the cavity chamber 140 on the swirling flow formed in the abacus ball-shaped cavity chamber 140. The swirling material to be pulverize is pulverized into fine powder by colliding with the diamond electrodeposited layer 132c formed on the inner surface of the abacus ball-shaped cavity chamber 140 of the pulverizing section 130, or by colliding with other material to be pulverized.

Since the diamond electrodeposited layer 132c is formed on the inner surface of the cavity chamber 140 where the material to be pulverized collide, the diamond electrodeposited layer 132c is not scraped off and mixed into the product fine powder even if the material to be pulverized collide with each other.

The pulverized fine powder swirls at high speed in the abacus ball-shaped cavity chamber 140 in the swirling flow and rises in the cavity chamber 140. The swirling and rising fine powder passes through the opening 133a in the center of the partition plate 133 and is discharged outside through the fine powder outlet 154 to be collected as fine powder as a product.

In the present embodiment, the cavity chamber 140 is shaped like an abacus ball, which has the following effects. First, since the cavity chamber 140 is abacus-shaped, the swirling flow can be made faster due to the reduced cavity volume compared to a cylindrical shape. Also, since the cavity chamber 140 is abacus-shaped, the wall angle can be the same as the angle of the high-speed jet from the jet nozzle, thus increasing the speed of the swirling flow. Furthermore, since the cavity chamber 140 is abacus-shaped, the swirling flow is faster and the impact distance to the wall surface is shorter, which amplifies the impact energy and enables finer powdering.

Thus, according to the present embodiment, the jet mill device with excellent wear resistance due to powder can be realized.

### Fifth Embodiment

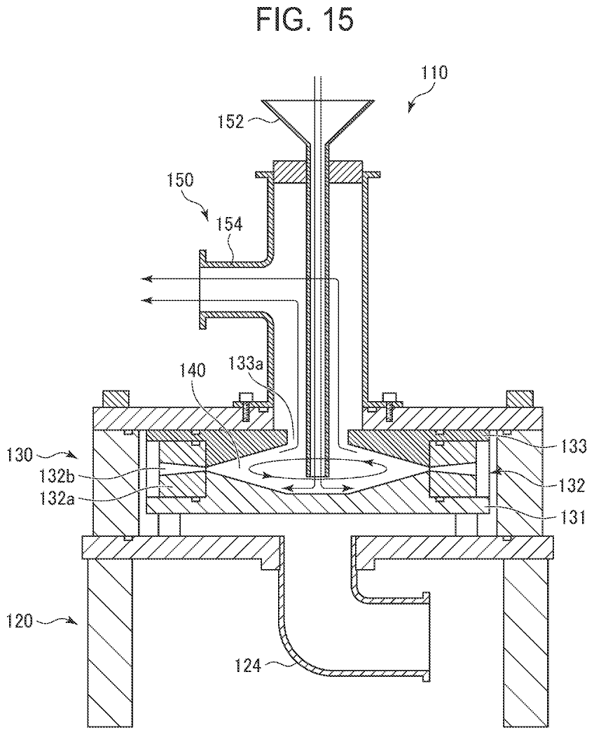

The jet mill device according to the fifth embodiment of the present invention will be described using FIG. 15.

In the jet mill device 110 of the present embodiment, unlike the jet mill device 110 according to the fourth embodiment of the present invention, the diamond electrodeposited layer 132c is not formed on the inner surface of the cavity chamber 140 where the material to be pulverized is impacted. The other configuration is the same as the jet mill device 110 according to the fourth embodiment of the present invention.

In the jet mill device 110 according to the present embodiment, the inner surface of the cavity chamber 140 is formed of a material harder than the material to be pulverized.

Or, the jet mill device 110 of the present embodiment is used only for the pulverization process of the material to be pulverized whose hardness is lower than the hardness of the material of the inner surface of the cavity chamber 140.

### Sixth Embodiment

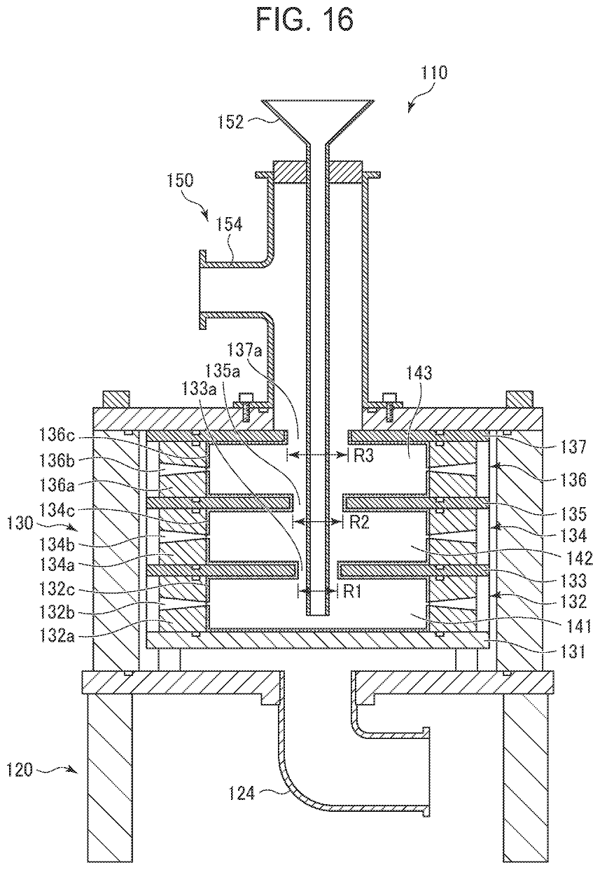

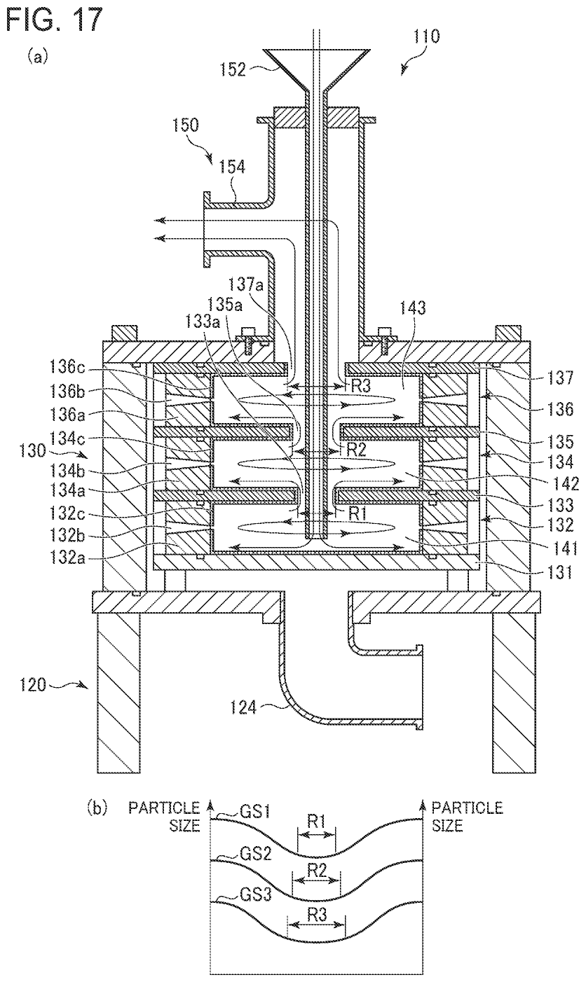

The jet mill device according to the sixth embodiment of the invention is described using FIG. 16 and FIG. 17. FIG. 16 is a longitudinal cross-sectional view of the jet mill device 110 of the present embodiment.

### (Configuration of Jet Mill Device)

The jet mill device 110 of the present embodiment comprises a base section 120, a cylindrical pulverizing section 130 provided on the base section 120 that pulverizes the material to be pulverized into fine powder, and an input/output section 150 provided on the pulverizing section 130 that inputs the material to be pulverized to the pulverizing section 130 and outputs the pulverized fine powder from the pulverizing section 130.

Within the pulverizing section 130, there are cavity chambers 141, 142, 143 in which the material to be pulverized is pulverized and processed. The input/output section 150 feeds the material to be pulverized into the cavity chamber 141 of the pulverizing section 130 and retrieves the pulverized fine powder from the cavity chamber 143 of the pulverizing section 130.

### (Base Section)

The base section 120 of the jet mill device according to the present embodiment is provided with a compressed air tank (not shown) that feeds compressed air into the cavity chamber 140 of the pulverizing section 130. The compressed air tank (not shown) has a compressed air connection port 124. A compressor (not shown) that generates compressed air is connected to the compressed air connection port 124.

Compressed air generated by the compressor (not shown) is sent from the compressed air connection port 124 to the pulverizing section 130.

### (Pulverizing Section (Air Flow Generator))

The pulverizing section 130 of the jet mill device according to the present embodiment comprises an underplate 131 provided at the bottom of the cavity chamber 141, a jet ring 132 provided on the underplate 131, a partition plate 133 provided on the jet ring 132, a jet ring 134 provided on the partition plate 133, a partition plate 135 provided on the jet ring 134, a jet ring 136 provided on the partition plate 135, and a partition plate 137 provided on jet ring 136.

The jet rings 132, 134, 136 are similar in configuration to the jet ring 44 of the first embodiment shown in FIG. 7. The jet rings 132, 134, and 136 have a plurality of jet nozzles 132b, 134b, 136b, respectively, on the doughnut-shaped jet ring body 132a, 134a, 136a. For example, in FIG. 7(a), the 12 jet nozzles 132b, 134b, 136b are provided at approximately 30 degree intervals. The plurality of the jet nozzles 132b, 134b, 136b generate a swirling air flow in the cavity chambers 141, 142, 143.

The shape and arrangement of the jet nozzles 132b, 134b, 136b are similar to the jet nozzle 44b of the jet ring 44 of the first embodiment shown in FIG. 7.

The jet ring 132 is sandwiched between the underplate 131 and the partition plate 133 to form a cavity chamber 141 in the pulverizing section 130. The jet ring 134 is sandwiched between the partition plate 133 and the partition plate 135 to form a cavity chamber 142 in the pulverizing section 130. The jet ring 136 is sandwiched between the partition plate 135 and the partition plate 137 to form a cavity chamber 143 in the pulverizing section 130.

The partition plate 133 has an opening 133a in the center. The diameter of the opening 133a is R1. The partition plate 135 has an opening 135a formed in the center. The diameter of the opening 135a is R2. The partition plate 137 has an opening 137a in the center. The diameter of opening 137a is R3. The diameter R2 is larger than the diameter R1, and the diameter R3 is larger than the diameter R2.

Through the opening 133a of diameter R1 in the partition plate 133, the fine powder in the cavity chamber 141 moves into the cavity chamber 142, through the opening 135a of diameter R2 in the partition plate 135, the fine powder in the cavity chamber 142 moves into the cavity chamber 143, and through the opening 137a of diameter R3 in the partition plate 137, the fine powder in the cavity chamber 144 is output to the input/output section 150.

### (Input/Output Section)

As shown in FIG. 16, the input/output section 150 is provided on the pulverizing section 130, which inputs the material to be pulverized into the cavity chamber 140 of the pulverizing section 130, and outputs the pulverized fine powder from the cavity chamber 140 of the pulverizing section 130.

The input/output section 150 is provided with a material input pipe 152 for inputting the material to be pulverized into the cavity chamber 140 of the pulverizing section 130, and a fine powder outlet 154 for discharging the pulverized fine powder. The material input pipe 152 penetrates through the central openings 133a, 135a, 137a of the partition plates 133, 135, 137 of the pulverizing section 130, and its lower end reaches into the cavity chamber 141.

At the connection port between the input/output section 150 and the cavity chamber 140, there is no mesh to allow only fine powders of finer than predetermined particle size to pass through, but the openings 133a, 135a, 137a of diameters R1, R2, R3 in the center of partition plates 133, 135, 137 serve such function.

When the pulverized fine powder in the cavity chambers 141, 142, 143 of the pulverizing section 130 is swirled at high speed by the swirling air flow, as shown in FIG. 17(b), the particle size distributions of the fine powder in the cavity chambers 141, 142, 143 are the distributions which are fine in the center and coarse in the periphery, that is, the distributions GS1, GS2, GS3 in which the particle size of the fine powder in the center is small and the particle size of the surrounding fine powder is large.

Since the fine powder in the cavity chamber 141 moves from the cavity chamber 141 to the cavity chamber 142 through the opening 133a of diameter R1 in the center of the partition plate 133, only small fine powder, in which the fine particle size in the cavity chamber 141 is within the opening 133a of diameter R1 based on the particle size distribution GS1 of the fine powder in the cavity chamber 141, moves into the cavity chamber 142.

Since the fine powder in the cavity chamber 142 moves from the cavity chamber 142 to the cavity chamber 143 through the opening 135a of diameter R2 in the center of the partition plate 135, only small fine powder, in which the fine particle size in the cavity chamber 142 is within the opening 135a of diameter R2 based on the particle size distribution GS2 of the fine powder in the cavity chamber 142, moves into the cavity chamber 143.

Since the fine powder in the cavity chamber 143 outputs from the cavity chamber 142 to the input/output section 150 through the opening 137a of diameter R3 in the center of the partition plate 137, only small fine powder, in which the fine particle size in the cavity chamber 143 is within the opening 137a of diameter R3 based on the particle size distribution GS3 of the fine powder in the cavity chamber 143, is discharged our of the fine powder outlet 54 and collected as fine powder as product.

### (Operation of Jet Mill Device)

The operation of the jet mill device according to the present embodiment is described using FIG. 17.

First, a compressor (not shown) that generates compressed air is activated and compressed air from a compressed air tank (not shown) is fed through the compressed air connection port 124. The compressed air is sent to the pulverizing section 130 and is ejected from a plurality of jet nozzles 132b, 134b, 136b in the jet rings 132, 134, 136 to generate swirling air flows in the cavity chambers 141, 142, 143.

Next, a material to be pulverized is fed into the cavity chamber 141 of the pulverizing section 130 from the material input pipe 152 of the input/output section 150. The fed material to be pulverized is swirled in the cavity chamber 141 by the swirling flow formed in the cavity chamber 141. The swirling material to be pulverized is pulverized into fine powder by colliding with the diamond electrodeposited layer 132c formed on the inner surface of the cavity 141 of the pulverizing section 130, or by colliding with other material to be pulverized.

Then, the fine powder that moves into the cavity chamber 142 is swirled in the cavity chamber 142 by the swirling flow formed in the cavity chamber 142. The swirling material to be pulverized is pulverized into fine powder by colliding with the diamond electrodeposited layer 134c formed on the inner surface of the cavity chamber 142 of the pulverizing section 130, or by colliding with other material to be pulverized.

Then, the fine powder that moves into the cavity chamber 143 is swirled in the cavity chamber 143 by the swirling flow formed in the cavity chamber 143. The swirling material to be pulverized is pulverized into fine powder by colliding with the diamond electrodeposited layer 136c formed on the inner surface of the cavity chamber 143 of the pulverizing section 130 or by colliding with other material to be pulverized.

Since the diamond electrodeposited layers 132c, 134c, 136c is formed on the inner surfaces of the cavity chambers 141, 142, 143 where the material to be pulverized collide, the diamond electrodeposited layers 132c, 134c, 136c are not ground off and mixed into the fine powder of the product when the material to be pulverized collide.

Finally, the pulverized fine powder swirls at high speed in the cavity chamber 143 on the swirling flow and rises in the cavity chamber 143. The swirling and rising fine powder passes through the opening 137a in the center of the partition plate 137 and is discharged outside through the fine powder outlet 154 to be collected as fine powder as product.

Thus, according to the present embodiment, the jet mill device with excellent wear resistance due to powder can be realized.

The shape of the cavity chambers 141, 142, 143 in the jet mill device according to the sixth embodiment of the invention may be the so-called abacus ball shape, which is thicker in the center and thinner at the periphery, as shown in FIG. 14, like the cavity chamber 140 in the jet mill device according to the sixth embodiment of the invention.

### Seventh Embodiment

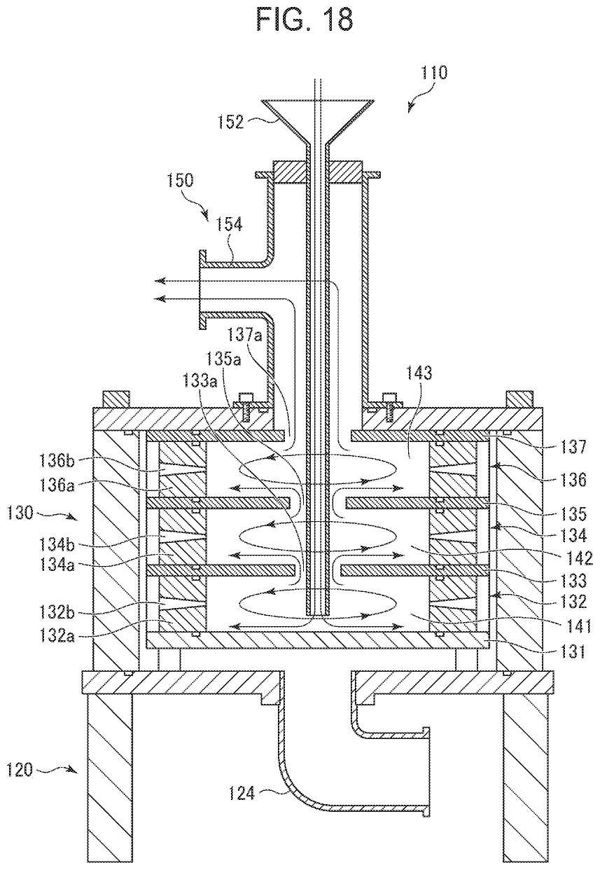

The jet mill device according to the seventh embodiment of the present invention is described using FIG. 18.

In the jet mill device 110 of the present embodiment, unlike the jet mill device 110 according to the sixth embodiment of the invention, present the diamond electrodeposited layers 132c, 134c, 136c are not formed on the inner surface of the cavity chambers 141, 142, 143 where the material to be pulverized is impacted. The other configuration is the same as the jet mill device 110 according to the third embodiment of the present invention.

In the present embodiment of the jet mill device 110, the inner surfaces of the cavity chambers 141, 142, 143 are formed of a material harder than the material to be pulverized.

Or, the jet mill device 110 of the present embodiment is used only for the pulverization process of the material to be pulverized whose hardness is lower than the hardness of the material of the inner surface of the cavity chambers 141, 142, 143.

The shape of the cavity chambers 141, 142, 143 in the jet mill device according to the seventh embodiment of the invention may be the so-called abacus ball shape, which is thicker in the center and thinner at the periphery, as shown in FIG. 14, like the cavity chamber 140 in the jet mill device according to the fourth embodiment of the invention.

### Eighth Embodiment

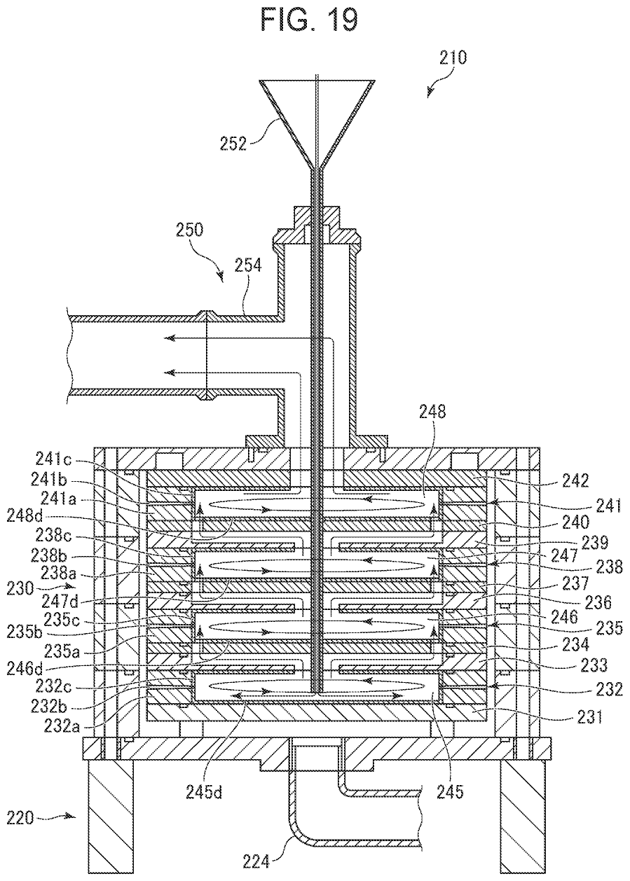

The jet mill device according to the eighth embodiment of the present invention is described using FIGS. 19 to 25. FIG. 19 is a longitudinal sectional view of the jet mill device 210 of the present embodiment.

### (Configuration of Jet Mill Device)

The jet mill device 210 of the present embodiment comprises a base section 220, a cylindrical pulverizing section 230 provided on the base section 220 that pulverizes the material to be pulverized into fine powder, and an input/output section 250 provided on the pulverizing section 230 that inputs the material to be pulverized to the pulverizing section 230 and outputs the pulverized fine powder from the pulverizing section 230.

Within the pulverizing section 230, there are cavity chambers 245, 246, 247, 248 in which the material to be pulverized is pulverized and processed. The input/output section 250 feeds the material to be pulverized into the cavity chamber 245 on the lowest level of the pulverizing section 230 and retrieves the pulverized fine powder from the cavity chamber 248 on the highest level of the pulverizing section 230.

### (Base Section)

The base section 220 of the jet mill device 210 according to the present embodiment is provided with a compressed air tank (not shown) that feeds compressed air into the cavity chambers 245, 246, 247, and 248 of the pulverizing section 230. The compressed air tank (not shown) has a compressed air connection port 224. A compressor (not shown) that generates compressed air is connected to the compressed air connection port 224.

Compressed air generated by the compressor (not shown) is sent from the compressed air connection port 224 to the pulverizing section 230.

### (Pulverizing Section: Basic Structure (Air Flow Generator))

An underplate 231 is provided at the bottom of the pulverizing section 230 of the jet mill device 210 according to the present embodiment.

On the underplate 231, a first jet ring 232 is provided to form the first-stage cavity chamber 245. A diamond electrodeposited layer 245d is formed on the inner wall of the cavity chamber 245.

A first partition plate 233 is provided on the first jet ring 232, a second partition plate 234 is provided on the first partition plate 233, and a second jet ring 235 is provided on the second partition plate 234 to form a second-stage cavity chamber 246. A diamond electrodeposited layer 246d is formed on the inner wall of the cavity chamber 246.

A first partition plate 236 is provided on the second jet ring 235, a second partition plate 237 is provided on the first partition plate 236, and a second jet ring 238 is provided on the second partition plate 237 to form a third-stage cavity chamber 247. A diamond electrodeposited layer 247d is formed on the inner wall of the cavity chamber 247.

A first partition plate 239 is provided on the second jet ring 238, a second partition plate 240 is provided on the first partition plate 239, and a second jet ring 241 is provided on the second partition plate 240 to form a fourth-stage cavity chamber 248. A diamond electrodeposited layer 248d is formed on the inner wall of the cavity chamber 248.

A top plate 242 is provided at the top of the pulverizing section 230 on the second jet ring 241.

### (Pulverizing Section: Jet Ring)

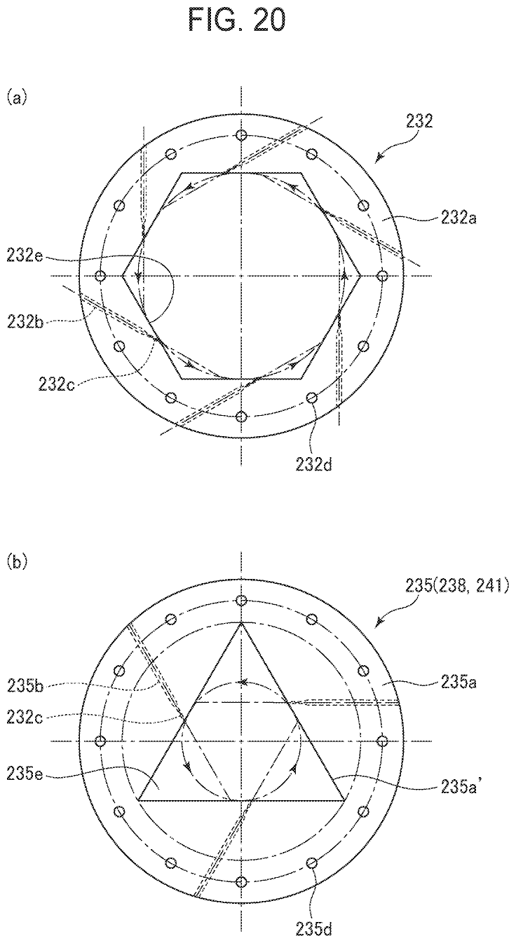

FIG. 20 shows the first jet ring 232 and the second jet rings 235, 238, 241 of the jet mill device 210 according to the present embodiment. In the present embodiment, the structure of the first jet ring 232 for forming the first-stage cavity chamber 245 of the pulverizing section 230, and the second jet rings 235, 238 and 241 for forming the second-stage to fourth-stage cavity chambers 246, 247, 248 of the pulverizing section 230 are different.

The first jet ring 232 is shown in FIG. 20(a). In the first jet ring 232, a doughnut-shaped jet ring body 232a is provided with a plurality of jet nozzles 232b that inject air. The outer circumference of the jet ring body 232a is circular and the inner circumference of the jet ring body 232a is hexagonal. The outer circumference of the jet ring body 232a has a plurality of through holes 232d for stacking. The hexagonal opening 232e of the jet ring body 232a defines the cavity chamber 245 of the first stage.

Each side of the hexagonal opening 232e of the jet ring body 232a is provided with a jet nozzle 232b. A jet opening 232c for injecting air is formed at the tip of the jet nozzle 232b. The jet nozzles 232b are mounted in such a direction that the air jets from the jet openings 232c do not intersect with each other and hit almost the center of adjacent sides of the hexagonal opening 232e. In other words, the position of the jet opening 232c of the jet nozzle 232b is offset from the center of each side of the hexagonal opening 232e, and the direction of the air jet is oriented in a position offset from the center of adjacent sides of the hexagonal opening 232e. The plurality of jet nozzles 232b thus provided generate a large air flow that swirls in the cavity chamber 245 defined by the hexagonal openings 232e of the jet ring body 232a. As shown in FIG. 20(a), a large air flow swirling in the left direction is generated in the cavity chamber 245 defined by the hexagonal opening 232e.

The second jet ring 235 (238, 241) is shown in FIG. 20(b). In the second jet ring 235, a doughnut-shaped jet ring body 235a is provided with a plurality of jet nozzles 235b for injecting air. The outer circumference of the jet ring body 235a is circular and the inner circumference of the jet ring body 235a is triangular. The outer circumference of the jet ring body 235a has a plurality of through holes 235d for stacking. The triangular openings 235e in the jet ring body 235a define the second, third, and fourth-stage cavity chambers 246, 247, and 248.

Each side of the triangular opening 235e of the jet ring body 235a is provided with a jet nozzle 235b. A jet opening 235c for injecting air is formed at the tip of the jet nozzle 235b. The jet nozzles 235b are mounted in such a direction that the air jets from the jet openings 235c do not intersect with each other and hit almost the center of adjacent sides of the triangular opening 235e. In other words, the position of the jet opening 235c of the jet nozzle 235b is offset from the center of each side of the triangular opening 235e, and the direction of the air jet is oriented in a position offset from the center of the adjacent sides of the triangular opening 235e. The plurality of jet nozzles 235b thus provided generate air flows that swirl in the cavity chambers 246, 247, 248. As shown in FIG. 20(b), large air flows swirling in the left direction are generated in the cavity chambers 246, 247, 248 defined by the triangular opening 235e.

The opening 232e of the first jet ring 232 may be hexagon or more polygon in shape, giving priority to the function of suctioning the material to be pulverized efficiently.

The opening 235e of the second jet ring 235 (238, 240) may be polygon less than hexagon in shape, giving priority to the function of walling off the material to be pulverized.

### (Pulverizing Section: Partition Plate)

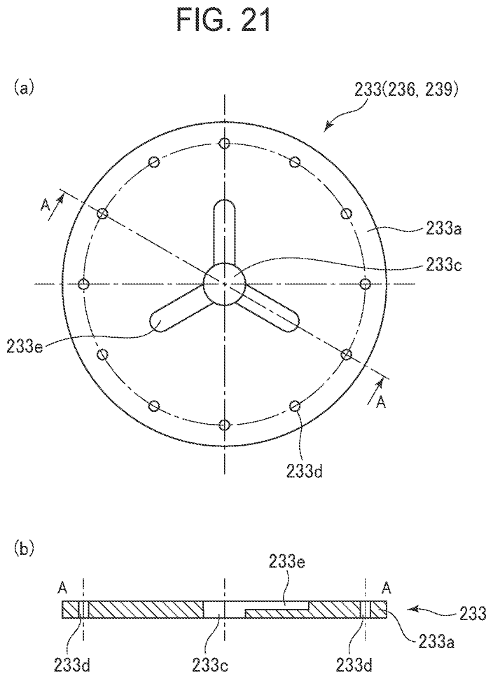

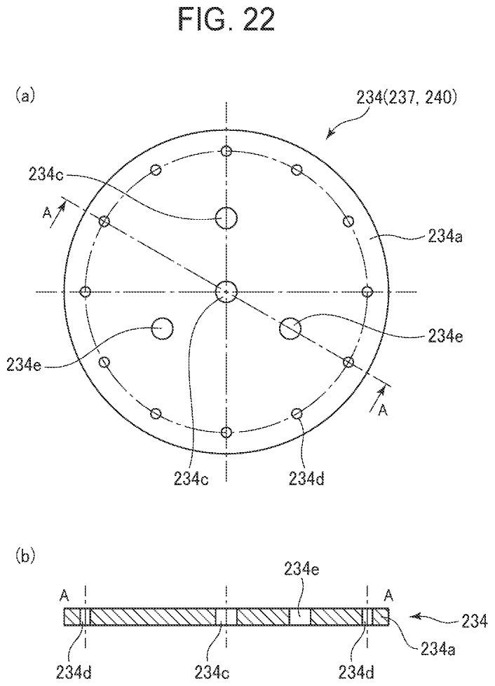

FIG. 21 and FIG. 22 show the first partition plate 233 (236, 239) and the second partition plate 234 (237, 240) of the present embodiment. FIG. 21(a) is a plan view of the first partition plate 233 (236, 239) and FIG. 21(b) is a cross-sectional view of the first partition plate 233 (236, 239). FIG. 22(a) is a plan view of the second partition plate 234 (237, 240) and FIG. 22(b) is a cross-sectional view of the second partition plate 234 (237, 240).

The first partition plate 233 and the second partition plate 234 guide fine particles swirling in the first-stage cavity chamber 245 into the second-stage cavity chamber 246. The first partition plate 236 and the second partition plate 237 guide fine particles swirling in the second-stage cavity chamber 246 into the third-stage cavity chamber 247. The first partition plate 239 and the second partition plate 240 guide fine particles swirling in the third-stage cavity chamber 247 into the fourth-stage cavity chamber 248.

The circumference of the partition plate body 233a of the first partition plate 233 (236, 239) is circular, and a plurality of through holes 233d are formed in the circumference of the partition plate body 233a for stacking. A through hole 233c is formed in the center of the partition plate body 233a. Three guide grooves 233e are formed in the partition plate body 233a from the central through hole 233c toward the outside.

The outer circumference of the partition plate body 234a of the second partition plate 234 (237, 241) is circular, and a plurality of through holes 234d for stacking are formed in the outer circumference of the partition plate body 234a. A through hole 234c is formed in the center of the partition plate body 234a. Three supply holes are formed in the partition plate body 234a at positions outward from the central through hole 233c. The positions of the three supply holes 234e of the second partition plate 234 match the positions of the ends of the three guide grooves 233e of the first partition plate 233, respectively.

By stacking the first partition plate 233 and the second partition plate 234, an induction path of fine particles continuous from the guide grooves 233e to the supply holes 234e is formed.

(Pulverizing Section: Swirling Flow in Cavity Chamber after Second-Stage)

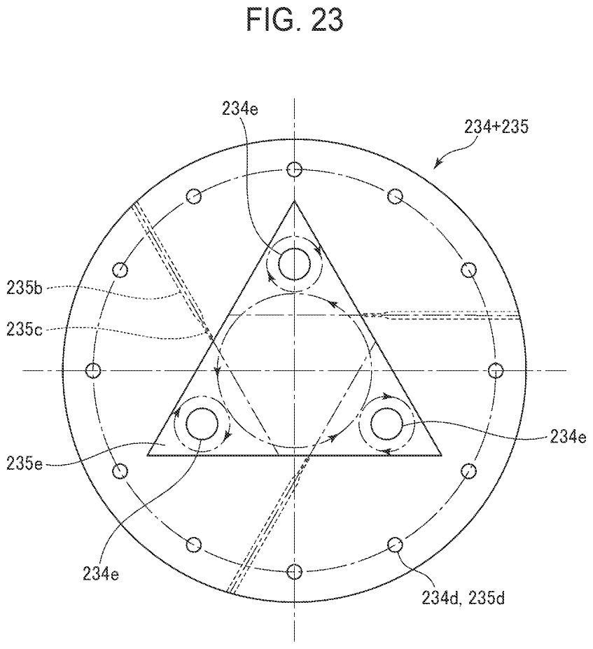

The swirling flow in the second and subsequent cavity chambers 246, 247, 248 of the pulverizing section 230 in the jet mill device 210 according to the present embodiment is explained using FIG. 23.

FIG. 23 shows a superimposed view of the second jet ring 235, which forms the second-stage cavity chamber 246, and the second partition plate 234, which supplies fine particles to the second-stage cavity chamber 246.

As shown in FIG. 23, the three supply holes 234e of the second partition plate 234 are located near each apex of the triangular opening 235e of the second jet ring 235. The three jet nozzles 235b of the second jet ring 235 are located on each side of the triangular opening 235e. The jet nozzles 235b of the second jet ring 235 are provided so that their air jet direction faces the adjacent sides of the triangular opening 235e and passes inside the triangular opening 235e from the supply hole 234e of the second partition plate 234.

Since the jet nozzles 235b are provided on each side of the triangular opening 235e of the second jet ring 235, a high-speed swirling flow is generated in the triangular cavity chamber 246.

Since the position of the jet opening 235c of the jet nozzle 235b is offset from the center of each side of the triangular opening 235e, and the air jet direction is directed to a position offset from the center of the adjacent side of the triangular opening 235e, the fine particles swirled by the swirling flow continuously impact the wall surface of the cavity chamber 246.

Since the three supply holes 234e of the second partition plate 234 are located near each apex of the triangular openings 235e of the second jet ring 235, fine particles from the lower first-stage cavity chamber 245 are not supplied directly to the center of the second-stage cavity chamber 246.

This has the following advantages. First, by feeding from the first stage to the corner of the triangle of the second stage, the feed flow velocity can be reduced to ⅓. In addition, the three jet nozzles in the second-stage triangle generate a large and strong main swirling flow on each side of the triangle, and a counter-rotating swirling flow is generated near areas surrounded by two sides of the triangular opening 235e. This allows for more efficient wall collisions and also promotes inter-particle collisions.

Due to the high-speed large swirling flow in the triangular cavity chamber 246, a small swirling flow is generated in the vicinity of the three supply holes 234e of the second partition plate 234.

The small swirling flow near the three supply holes 234e of the second partition plate 234 causes fine particles to continuously impact the walls of the cavity chamber 246, and the large swirling flow in the center of the cavity chamber 246 causes fine particles to continuously impact the walls of the cavity chamber 246.

Similarly in the third-stage and fourth-stage cavity chambers 247 and 248 after the second-stage, a large central swirling flow and three smaller swirling flows are generated, which cause fine particles to collide with the walls of the cavity chambers 247 and 248, resulting in finer particles.

### (Pulverizing Section: Swirling Flow in First-Stage Cavity Chamber and Swirling Flow in Second-Stage and Subsequent Cavity Chambers)

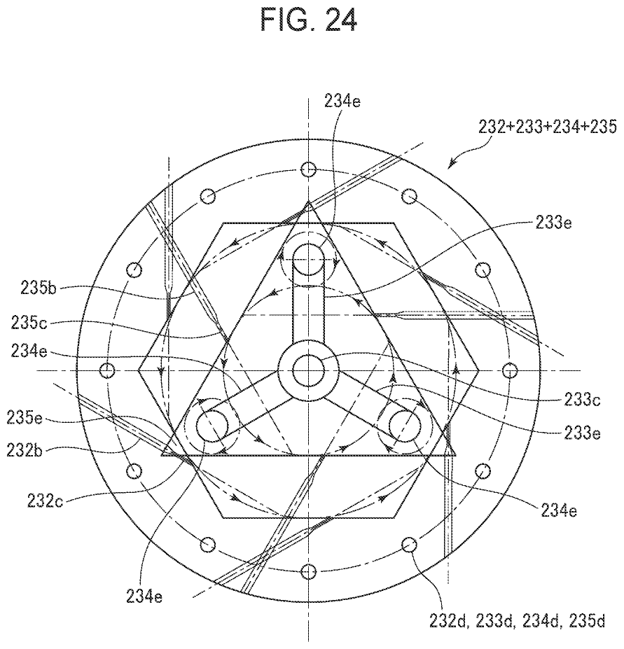

The swirling flow in the first-stage cavity chamber 245 and the swirling flow in the second-stage and subsequent cavity chambers 246, 247, 248 of the pulverizing section 230 in the jet mill device 210 according to the present embodiment are explained using FIG. 24.

FIG. 24 is an superimposed view of superimposing the first jet ring 232 forming the first-stage cavity chamber 245, the first partition plate 233 on the first jet ring 232, the second partition plate 234 on the first partition plate 233, and the second jet ring 235 forming the second-stage cavity chamber 246.

Each vertex of the triangular opening 235e of the second jet ring 235 is located in the center of three sides of the hexagonal opening 232e of the first jet ring 232.

The three guide grooves 233e of the first partition plate 233 are formed in the area from the center of the triangular opening 235e of the second jet ring 235 toward the three vertices.

The three supply holes 234e of the second partition plate 234 are located near each apex of the triangular opening 235e of the second jet ring 235 and near three sides in the hexagonal opening 232e of the first jet ring 232.

As a result, a swirling flow is generated in the first-stage cavity chamber 245 defined by the opening 232e of the first jet ring 232 and the second-stage cavity chamber 246 defined by the opening 235e of the second jet ring 235, as shown in FIG. 24.

In the first-stage cavity chamber 245 defined by opening 232e of the first jet ring 232, a large swirling flow along the outer edge of the hexagonal opening 232e is generated by the jet nozzles 232b on each side of the hexagonal opening 232e.

In the second-stage cavity chamber 246 defined by opening 235e of the second jet ring 235, a large swirling flow in the triangular cavity chamber 246 and a small swirling flow near the three supply holes 234e of the second partition plate 234 are generated, as also shown in FIG. 23.

The swirling flow in the second-stage cavity chamber 246 is faster and more suited for finer size because the diameter of the swirling flow in the second-stage cavity chamber 246 is smaller than that in the first-stage cavity chamber 245.

### (Basic Principle of Jet Mill Pulverizing)

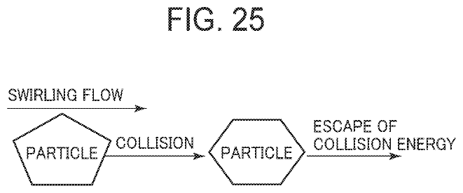

The basic principle of jet mill pulverizing is explained using FIG. 25.

The basic principle of jet mill pulverizing is that particles are refined by collisions between particles. However, when the finer particles become smaller than a predetermined particle diameter, the pulverizing efficiency is drastically reduced by particle-to-particle collisions alone, and eventually it becomes impossible to further refine the particles.

This is probably because, as shown in FIG. 25, particles are suspended in the cavity chamber on a swirling flow, so even if particles collide with each other, the collision energy escapes in the same direction as the swirling flow, and the particles are no longer pulverized.

Therefore, in the present invention, the particles are actively made to collide with the inner wall surface of the cavity chamber, and the particles are crushed by the collision. This makes it possible to refine particles to the nano-size level, which was considered impossible in the past.

### (Input/Output Section)

As shown in FIG. 19, there is the input/output section 250 on the pulverizing section 230, which inputs the material to be pulverized into the first-stage cavity chamber 245 of the pulverizing section 230 and outputs the pulverized fine powder from the fourth-stage cavity chamber 248 of the pulverizing section 230.

The input/output section 250 is provided with the material input pipe 252 for feeding material to be pulverized into the first-stage cavity chamber 245 of the pulverizing section 230, and the fine powder outlet 254 for discharging pulverized fine powder from the fourth-stage cavity chamber 248. The material input pipe 252 passes through the through holes 233c, 234c, 236c, 237c, 239c, 240c in the centers of the first partition plate 233, the second partition plate 234, the first partition plate 236, the second partition plate 237, the first partition plate 239, and the second partition plate 240 in the pulverizing section 230, through which its lower end reaches into the cavity chamber 245 of the first-stage. This feeds the raw material to the pulverizing section 230.

### (Operation of Jet Mill Device)

The operation of the jet mill device according to the present embodiment is explained using FIG. 19.

First, a compressor (not shown) that generates compressed air is activated and compressed air from a compressed air tank (not shown) is fed through the compressed air connection port 224. The compressed air is sent to the pulverizing section 230 and is jetted out from a plurality of jet nozzles 232b, 235b, 238b, and 241b in the first jet ring 232 and second jet rings 235, 238, 241 to generate a swirling air flow in the cavity chamber 245, 246, 247, 248.

Next, a material to be pulverized is fed into the cavity chamber 245 of the first stage of the pulverizing section 230 from the material input pipe 252 of the input/output section 250.

The material to be pulverized is swirled in the cavity chamber 245 by the swirling flow formed in the cavity chamber 245. The swirling material is pulverized into fine powder by colliding with the diamond electrodeposited layer 245d formed on the inner surface of the cavity chamber 245 of the pulverizing section 230 or by colliding with other material to be pulverized.

When the pulverized fine powder in the cavity chamber 245 of the first stage is swirled at high speed by the swirling air flow as indicated by the arrow, the particle size distribution of the fine powder in the cavity chamber 245 becomes fine in the center and coarse in the surroundings, that is, the particle diameter of the fine powder in the center is small and the particle diameter of the surrounding fine powder is large.

The fine powder in the first-stage cavity chamber 245 is guided into the grooves and openings formed in the first partition plate 233, and the second partition plate 234 to be fed into the second-stage cavity chamber 246, as shown by the arrow.

The fine powder fed into the second-stage cavity chamber 246 is then swirled in the cavity chamber 246 by the swirling flow formed in the cavity chamber 246. The swirling material to be pulverized is pulverized into fine powder by colliding with the diamond electrodeposited layer 246d formed on the inner surface of the cavity chamber 246 of the pulverizing section 230, or by colliding with other material to be pulverized.

When the pulverized fine powder in the second-stage cavity chamber 246 is swirled at high speed by the swirling air flow as indicated by the arrow, the particle size distribution of the fine powder in the cavity chamber 246 becomes a distribution with fine particles in the center and coarse particles in the periphery, i.e., the particle size of the fine powder in the center is small and the particle size of the surrounding fine powder is large.

The fine powder in the second-stage cavity chamber 246 is guided into the grooves and openings formed in the first partition plate 236 and the second partition plate 237 to be fed into the third-stage cavity chamber 247, as shown by the arrow.

The fine powder fed into the third-stage cavity chamber 247 is then swirled in the cavity chamber 247 by the swirling flow formed in the cavity chamber 247. The swirling material to be pulverized is pulverized into fine powder by colliding with the diamond electrodeposited layer 247d formed on the inner surface of the cavity chamber 247 of the pulverizing section 230 or by colliding with other material to be pulverized.

When the pulverized fine powder in the third-stage cavity chamber 247 is swirled at high speed by the swirling air flow as indicated by the arrow, the particle size distribution of the fine powder in the cavity chamber 247 becomes fine in the center and coarse in the surroundings, that is, the particle diameter of the fine powder in the center is small and the particle diameter of the surrounding fine powder is large.

The fine powder in the third-stage cavity chamber 247 is guided into the grooves and openings formed in the first partition plate 239 and the second partition plate 240 to be fed into the fourth-stage cavity chamber 248, as shown by the arrow.

The fine powder fed into the fourth-stage cavity chamber 248 is then swirled in the cavity chamber 248 by the swirling flow formed in the cavity chamber 248. The swirling material to be pulverized is pulverized into fine powder by colliding with the diamond electrodeposited layer 248d formed on the inner surface of the cavity chamber 248 of the pulverizing section 230 or by colliding with other material to be pulverized.

When the pulverized fine powder in the fourth-stage cavity chamber 248 is swirled at high speed by the swirling air flow as indicated by the arrow, the particle size distribution of the fine powder in the cavity chamber 248 becomes fine in the center and coarse in the surrounding area, that is, the particle diameter of the fine powder in the center is small and the particle diameter of the surrounding fine powder is large.

The fine powder in the fourth-stage cavity chamber 248 is output from the opening in the center of the top plate 242 to the input/output section 250, as indicated by the arrow. Only the fine powder with small particle size is discharged out of the fine powder outlet 254 and collected as product fine powder.

Since diamond electrodeposited layers 245d, 246d, 247d, 248d are formed on the inner surfaces of cavity chambers 245, 246, 247, 248 where the material to be pulverized collide, the diamond electrodeposited layers 245d, 246d, 247d, 248d are not scraped off and mixed with the fine powder of the product even if the material to be pulverized collides them.

Thus, according to the present embodiment, the jet mill device with excellent wear resistance due to powder can be realized.

### Ninth Embodiment

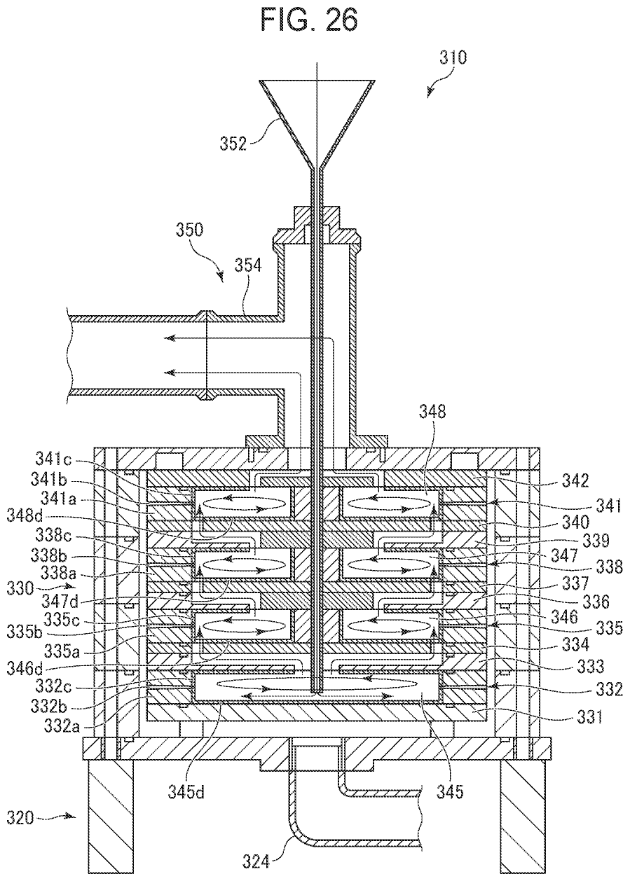

The jet mill device according to the ninth embodiment of the present invention is described using FIGS. 26 to 33. FIG. 26 is a longitudinal sectional view of the jet mill device 310 of the present embodiment.

### (Configuration of Jet Mill Device)

The jet mill device 310 of the present embodiment consists of a base section 320, a cylindrical pulverizing section 330 on the base section 320 that pulverizes the material to be pulverized into fine powder, and an input/output section provided on the pulverizing section 330 that inputs the material to be pulverized to the pulverizing section 330 and outputs the pulverized fine powder from the pulverizing section 330.

A plurality of cavity chambers 345, 346, 347, 348 are provided in the pulverizing section 330, in which the material to be pulverized is processed for pulverization. The input/output section 350 feeds the material to be pulverized into the cavity chamber 345 on the lowest level of the pulverizing section 330 and retrieves the pulverized fine powder from the cavity chamber 348 on the highest level of the pulverizing section 330.

### (Base Section)

The base section 320 of the jet mill device 310 according to the present embodiment is provided with a compressed air tank (not shown) that feeds compressed air into the cavity chambers 345, 346, 347, 348 of the pulverizing section 330. The compressed air tank (not shown) has a compressed air connection port 324. A compressor (not shown) that generates compressed air is connected to the compressed air connection port 324.

Compressed air generated by the compressor (not shown) is sent from the compressed air connection port 324 to the pulverizing section 330.

### (Pulverizing Section: Basic Structure (Air Flow Generator))

An underplate 331 is provided at the bottom of the pulverizing section 330 of the jet mill device 310 according to the present embodiment.

On the underplate 331, a first jet ring 332 is provided to form a first-stage cavity chamber 345. A diamond electrodeposited layer 345d is formed on the inner wall of the cavity chamber 345.

A first partition plate 333 is provided on the first jet ring 332, a second partition plate 334 is provided on the first partition plate 333, and a second jet ring 335 is provided on the second partition plate 334 to form a second-stage cavity chamber 346. A diamond electrodeposited layer 346d is formed on the inner wall of the cavity chamber 346.

A third partition plate 336 is provided on the second jet ring 335, a fourth partition plate 337 is provided on the third partition plate 336, and a second jet ring 338 is provided on the fourth partition plate 337 to form a third-stage cavity chamber 347. A diamond electrodeposited layer 347d is formed on the inner wall of the cavity chamber 347.

A third partition plate 339 is provided on the second jet ring 338, a fourth partition plate 340 is provided on the third partition plate 339, and a second jet ring 341 is provided on the fourth partition plate 340 to form a fourth-stage cavity chamber 348. A diamond electrodeposited layer 348d is formed on the inner wall of the cavity chamber 348.

A top plate 342 is provided at the top of the pulverizing section 330 on the second jet ring 341.

### (Pulverizing Section: Jet Ring)

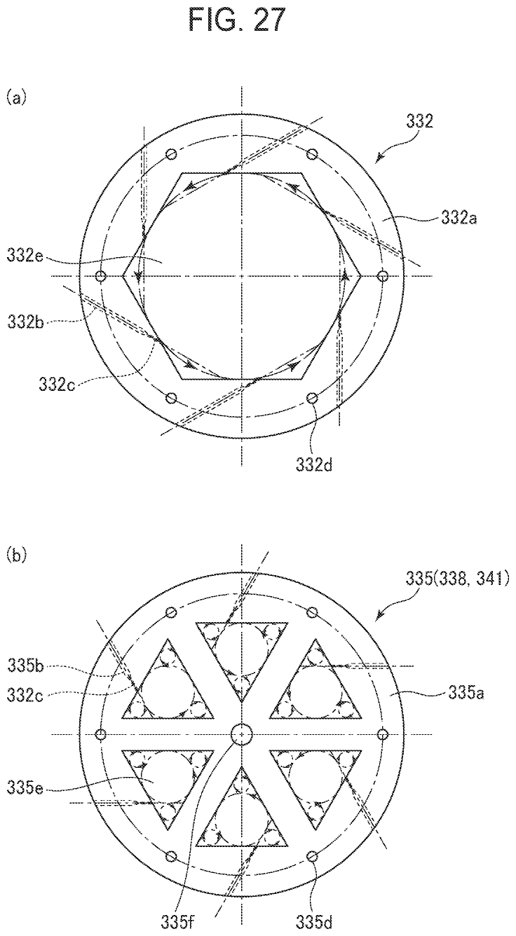

FIG. 27 shows the first jet ring 332 and the second jet rings 335, 338 and 341 of the jet mill device 310 according to the present embodiment. In the present embodiment, the structure of the first jet ring 332 for forming the first-stage cavity chamber 345 of the pulverizing section 330 and the second jet rings 335, 338 and 341 for forming the second to fourth-stage cavity chambers 346, 347 and 348 of the pulverizing section 330 are different.

The first jet ring 332 is shown in FIG. 27(a). In the first jet ring 332, a doughnut-shaped jet ring body 332a is provided with a plurality of jet nozzles 332b for injecting air. The outer circumference of the jet ring body 332a is circular and the inner circumference is hexagonal. The outer circumference of the jet ring body 332a has a plurality of through holes 332d for stacking. The hexagonal opening 332e of the jet ring body 332a defines the cavity chamber 345 of the first stage.

A jet nozzle 332b is provided on each side of the hexagonal opening 332e of the jet ring body 332a. An air jet opening 332c is formed at the tip of the jet nozzle 332b. The jet nozzles 332b are mounted in such a direction that the air jets from the jet openings 332c do not intersect with each other and hit almost the center of adjacent sides of the hexagonal opening 332e. In other words, the position of the jet opening 332c of the jet nozzles 332b is offset from the center of each side of the hexagonal opening 332e, and the direction of the air jet is oriented in a position offset from the center of adjacent sides of the hexagonal opening 332e. The plurality of jet nozzles 332b provided in this manner generates a large air flow that swirls in the cavity chamber 345. As shown in FIG. 27(a), a large swirling flow swirling to the left is generated in the cavity chamber 345 defined by the hexagonal opening 332e.

The second jet ring 335 (338, 341) is shown in FIG. 27(b). In the second jet ring 335, a doughnut-shaped jet ring body 335a is provided with a plurality of jet nozzles 335b that inject air. The outer circumference of the jet ring body 335a is circular, and six triangular openings 335e are formed inside. The periphery of the jet ring body 335a has a plurality of through holes 335d for stacking. The six triangular openings 335e in the jet ring body 335a define six second-stage, third-stage and fourth-stage cavity chambers 346, 347, 348.

Each of the six triangular openings 335e of the jet ring body 335a is provided with a jet nozzle 335b. An air jet opening 335c is formed at the tip of the jet nozzle 335b. The jet nozzles 335b are provided on the outer circumferential sides of the triangular openings 335e and are mounted so that the direction of the air jet hits the adjacent side of the triangular openings 335e. The jet nozzles 335b provided in this manner generate a swirling air flow in the cavity chambers 346, 347, 348 defined by the triangular openings 335e. As shown in FIG. 27(b), a large leftward swirling flow in the center of the triangular cavity chambers 346, 347, 348 defined by the triangular opening 335e and a smaller rightward swirling flow in the three corners of the triangular cavity chambers 346, 347, 348 are generated.

The opening 332e of the first jet ring 332 may be hexagon or more polygon in shape, giving priority to the function of efficiently suctioning the material to be pulverized.

The openings 335e of the second jet ring 335 (338, 341) may be polygon less than hexagon in shape, giving priority to the function of walling off the crushed material.

### (Pulverizing Section: Partition Plate, Top Plate)

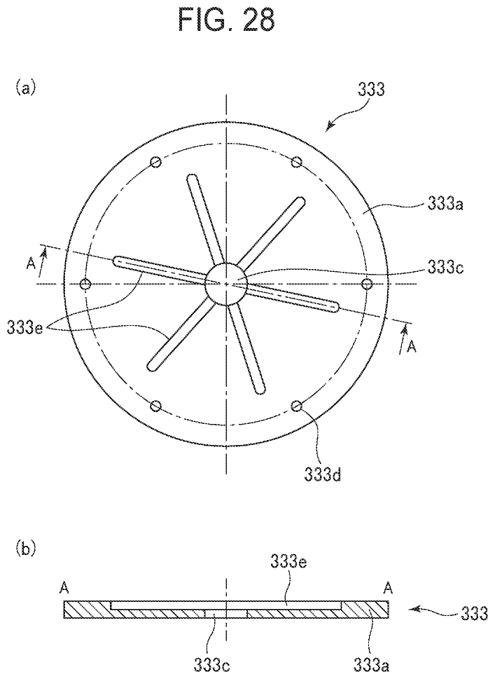

FIGS. 28 to 32 show the first partition plate 333, the second partition plate 334, the third partition plates 336, 339, the fourth partition plates 337, 340, and the top plate 342 in the present embodiment.

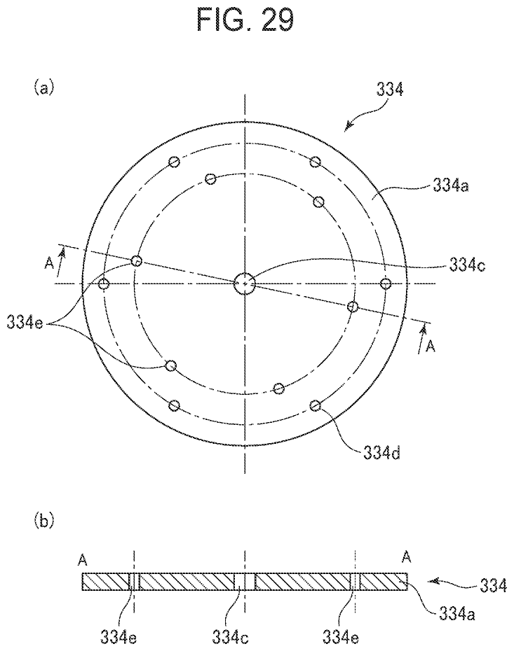

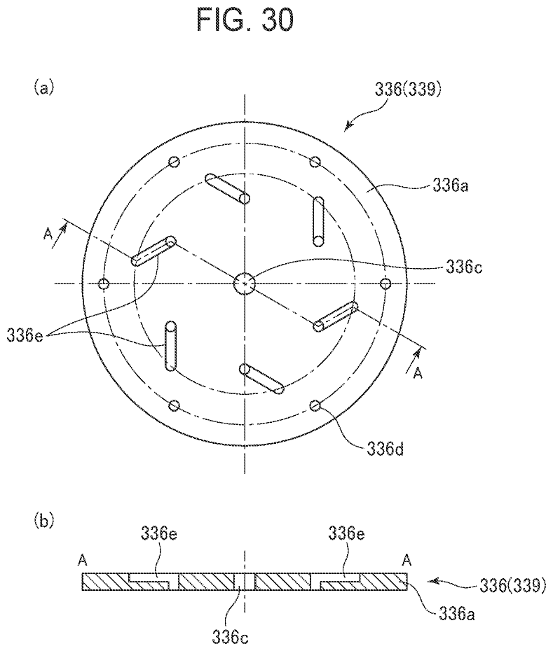

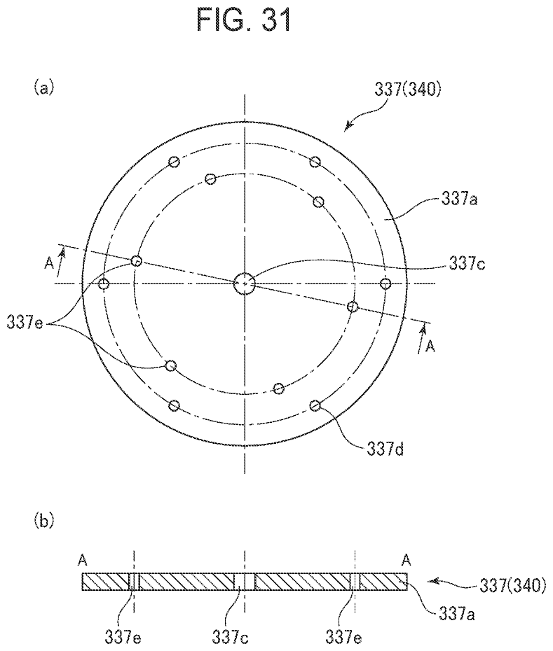

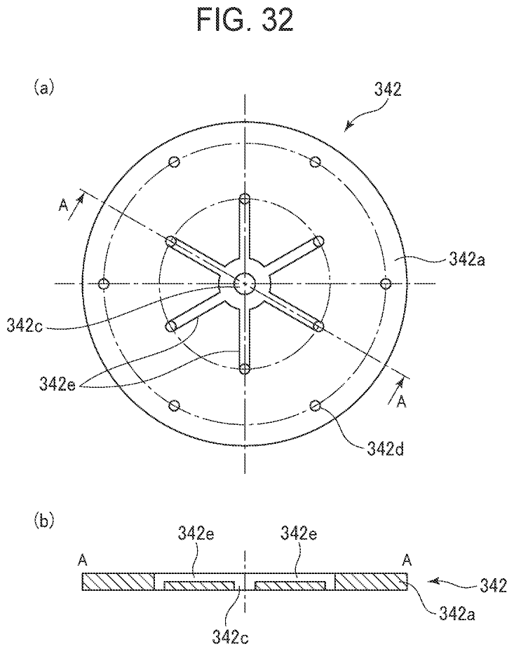

FIG. 28(a) is a plan view of the first partition plate 333, and FIG. 28(b) is a cross-sectional view of the first partition plate 333. FIG. 29(a) is a plan view of the second partition plate 334, and FIG. 29(b) is a cross-sectional view of the second partition plate 334. FIG. 30(a) is a plan view of the third partition plates 336, 339, and FIG. 30(b) is a cross-sectional view of the third partition plates 336, 339. FIG. 31(a) is a plan view of the fourth partition plates 337, 340, and FIG. 31(b) is a cross-sectional view of the fourth partition plates 337, 340. FIG. 32(a) is a plan view of the top plate 342, and FIG. 32(b) is a cross-sectional view of the top plate 342.

The first partition plate 333 and the second partition plate 334 guide the fine particles swirling through the first-stage cavity chamber 345 into the second-stage cavity chamber 346. The third partition plate 336 and the fourth partition plate 337 guide the fine particles swirling in the second-stage cavity chamber 346 into the third-stage cavity chamber 347. The third partition plate 339 and the fourth partition plate 340 guide the fine particles swirling in the third-stage cavity chamber 347 into the fourth-stage cavity chamber 348. The top plate 342 guides the fine particles swirling in the fourth-stage cavity chamber 348 to the input/output section 350.

The circumference of the partition plate body 333a of the first partition plate 333 is circular, and a plurality of through holes 333d are formed in the circumference of the partition plate body 333a for stacking. A through hole 333c is formed in the center of the partition plate body 333a. Six guide grooves 333e are formed in the partition plate body 333a from the central through hole 333c toward the outside.

The outer circumference of the partition plate body 334a of the second partition plate 334 is circular, and a plurality of through holes 334d for stacking are formed in the outer circumference of the partition plate body 334a. A through hole 334c is formed in the center of the partition plate body 334a. Six supply holes 334e are formed in the partition plate body 334a at positions outward from the central through hole 334c. The positions of the six supply holes 334e of the second partition plate 334 match the positions of the ends of the six guide grooves 333e of the first partition plate 333, respectively.

By stacking the first partition plate 333 and the second partition plate 334, an induction path of fine particles continuous from the guide grooves 333e to the supply holes 334e is formed.

The outer circumference of the partition plate body 336a of the third partition plate 336 (339) is circular, and a plurality of through holes 336d for stacking are formed in the outer circumference of the partition plate body 336a. A through hole 336c is formed in the center of the partition plate body 336a. Six guide grooves 336e are formed in the partition plate body 336a at positions outward from the central through hole 336c.

The outer circumference of the partition plate body 337a of the fourth partition plate 337 (340) is circular, and a plurality of through holes 337d for stacking are formed in the outer circumference of the partition plate body 337a. A through hole 337c is formed in the center of the partition plate body 337a. Six supply holes 334e are formed in the partition plate body 337a at positions outward from the central through hole 337c. The positions of the six supply holes 337e of the fourth partition plate 337 match the positions of the ends of the six guide grooves 336e of the third partition plate 336, respectively.

By stacking the third partition plate 336 and the fourth partition plate 337, an induction path of fine particles continuous from the guide grooves 336e to the supply holes 337e is formed.

The circumference of the top plate body 342a of the top plate 342 is circular, and a plurality of through holes 342d for stacking are formed in the circumference of the top plate body 342a. A through hole 342c is formed in the center of the top plate body 342a. Six guide grooves 342e are formed in the top plate body 342a from the central through hole 342c toward the outside. The positions of the ends of the six guide grooves 342e of the top plate 342 match the positions of the six triangular openings 341e of the second jet ring 341.

(Pulverizing Section: Swirling flow in First-stage Cavity Chamber and Swirling Flow in Second-stage and Subsequent Cavity Chambers)

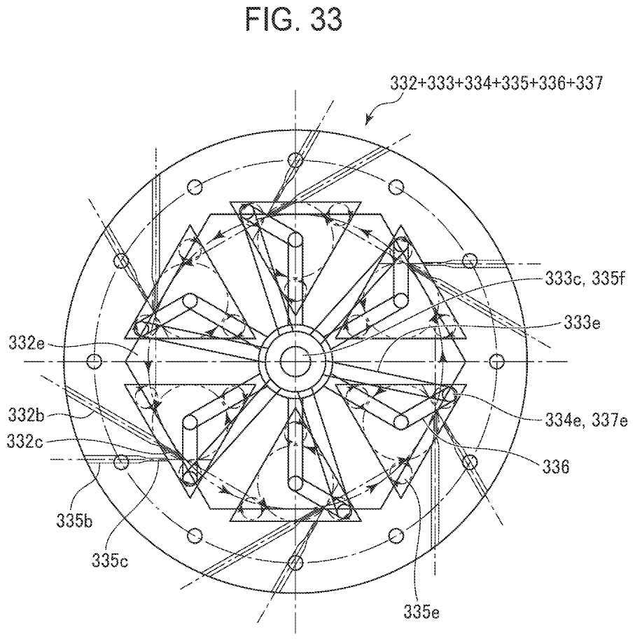

The swirling flow in the first-stage cavity chamber 345 and the swirling flow in the second and subsequent cavity chambers 346, 347, 348 of the pulverizing section 330 in the jet mill device 310 according to the present embodiment are explained using FIG. 33.

FIG. 33 is an superimposed view of superimposing a first jet ring 332 forming the first-stage cavity chamber 345, a first partition plate 333 on the first jet ring 332, a second partition plate 334 on the first partition plate 333, a second jet ring 335 forming the second-stage cavity chamber 346, a third partition plate 336 provided on the second jet ring 335, and a fourth partition plate 337 provided on the third partition plate 336.

The six triangular openings 335e of the second jet ring 335 are located near the six hexagonal openings 332e of the first jet ring 332.

The six guide grooves 333e of the first partition plate 333 are formed in the area toward the apex of the six triangular openings 335e of the second jet ring 335.

The six supply holes 334e of the second partition plate 334 are located at the ends of the six guide grooves 333e of the first partition plate 333.

As a result, a large swirling flow is generated in the first-stage cavity chamber 345 defined by the openings 332e of the first jet ring 332, and a relatively small swirling flow is generated in each of the six cavity chambers 346 in the second stage defined by the openings 335e of the second jet ring 335, respectively.

The six guide grooves 336e of the third partition plate 336 are formed in the area of the six triangular openings 335e of the second jet ring 335.

The six supply holes 337e of the fourth partition plate 337 are located at the ends of the six guide grooves 336e of the third partition plate 336.

As a result, a relatively small high velocity swirling flow is generated in each of the six cavity chambers 346 of the third stage defined by the openings 338e of the second jet ring 338.

The six guide grooves 339e of the third partition plate 339 are formed in the area of the six triangular openings 338e of the second jet ring 338.

The six supply holes 340e of the fourth partition plate 340 are located at the ends of the six guide grooves 339e of the third partition plate 339.

As a result, a relatively smaller and faster swirling flow is generated in each of the six cavity chambers 346 of the fourth stage defined by the openings 341e of the second jet ring 341.

### (Input/Output Section)

As shown in FIG. 26, an input/output section 350 is provided on the pulverizing section 330, which inputs the material to be pulverized into the first-stage cavity chamber 345 of the pulverizing section 330 and outputs the pulverized fine powder from the fourth-stage cavity chamber 348 of the pulverizing section 330.

The input/output section 350 is provided with a material input pipe 352 for feeding material to be pulverized into the first-stage cavity chamber 345 of the pulverizing section 330 and a fine powder outlet 354 for discharging pulverized fine powder from the fourth-stage cavity chamber 348. The material input pipe 352 passes through the through holes 333c, 334c, 336c, 337c, 337c, 339c, 340c in the center of the first partition plate 333, the second partition plate 334, the third partition plate 336, the fourth partition plate 337, the third partition plate 339, and the fourth partition plate 340 in the pulverizing section 330, through which its lower end reaches into the cavity chamber 345 of the first-stage. This feeds the raw material to the pulverizing section 330.

### (Operation of Jet Mill Device)

The operation of the jet mill device according to the present embodiment is explained using FIG. 26.

First, a compressor (not shown) that generates compressed air is activated and compressed air from a compressed air tank (not shown) is fed through compressed air connection port 324. The compressed air is sent to the pulverizing section 330 and is ejected from a plurality of the jet nozzles 333b, 335b, 338b, 341b in the first jet ring 332 and the second jet rings 335, 338, 341 to generate a swirling air flow in the cavity chambers 345, 346, 347, 348.

Next, a material to be pulverized is fed into the cavity chamber 345 of the first stage of the pulverizing section 330 from the material input pipe 352 of the input/output section 350.

The fed material to be pulverized swirls in the cavity chamber 345 on the swirling flow formed in the cavity chamber 345. The swirling material is pulverized into fine powder by colliding with the diamond electrodeposited layer 345d formed on the inner surface of the cavity chamber 345 of the pulverizing section 330, or by colliding with other material to be pulverized.

When the pulverized fine powder in the cavity chamber 345 of the first stage is swirled at high speed by the swirling air flow, the particle size distribution of the fine powder in the cavity chamber 345 becomes fine in the center and coarse in the surroundings, i.e., the particle diameter of the fine powder in the center is small and the particle diameter of the surrounding fine powder is large.

The fine powder in the first-stage cavity chamber 345 is guided into the grooves and openings formed in the first partition plate 333 and the second partition plate 334, and is fed into the second-stage cavity chamber 346.

The fine powder fed into the second-stage cavity chamber 346 is then swirled in the cavity chamber 346 by the swirling flow formed in the cavity chamber 346. The swirling material to be pulverized is pulverized into fine powder by colliding with the diamond electrodeposited layer 346d formed on the inner surface of the cavity chamber 346 in the pulverizing section 330, or by colliding with other material to be pulverized.

When the pulverized fine powder in the second-stage cavity chamber 346 is swirled at high speed by the swirling air flow, the particle size distribution of the fine powder in the cavity chamber 346 becomes fine in the center and coarse in the surroundings, i.e., the particle diameter of the fine powder in the center is small and the particle diameter of the surrounding fine powder is large.

The fine powder in the second-stage cavity chamber 346 is guided into the grooves and openings formed in the third partition plate 336 and the fourth partition plate 337 to be fed into the third-stage cavity chamber 347, as shown by the arrow.

The fine powder fed into the third-stage cavity chamber 347 is then swirled in the cavity chamber 347 by the swirling flow formed in the cavity chamber 347. The swirling material to be pulverized is crushed into fine powder by colliding with the diamond electrodeposited layer 347d formed on the inner surface of the cavity chamber 347 of the pulverizing section 330, or by colliding with other material to be pulverized.

When the pulverized fine powder in the third-stage cavity chamber 347 is swirled at high speed by the swirling air flow, the particle size distribution of the fine powder in the cavity chamber 347 becomes fine in the center and coarse in the surroundings, i.e., the particle size of the fine powder in the center is small and the particle size of the surrounding fine powder is large.

The fine powder in the third-stage cavity chamber 347 is guided into the grooves and openings formed in the third partition plate 339 and the fourth partition plate 340, and is fed into the fourth-stage cavity chamber 348.

The fine powder fed into the fourth-stage cavity chamber 348 is then swirled in the cavity chamber 348 by the swirling flow formed in the cavity chamber 348. The swirling material to be pulverized is crushed into fine powder by colliding with the diamond electrodeposited layer 348d formed on the inner surface of the cavity chamber 348 of the pulverizing section 330, or by colliding with other material to be pulverized.

When the pulverized fine powder in the cavity chamber 348 of the fourth stage is swirled at high speed by the swirling air flow as shown by the arrow, the particle size distribution of the fine powder in the cavity chamber 348 becomes fine in the center and coarse in the periphery, that is, the particle diameter of the fine powder in the center is small and the particle diameter of the surrounding fine powder is large.

The fine powder in the fourth-stage cavity chamber 348 is guided by the grooves in the top plate 342 and output from the center opening to the input/output section 350. Only the fine powder with small particle size is discharged out of the fine powder outlet 354 and collected as fine powder as a product.

Since diamond electrodeposited layers 345d, 346d, 347d, 348d are formed on the inner surfaces of the cavity chambers 345, 346, 347, 348 where the material to be pulverized collide, the diamond electrodeposited layers 345d, 346d, 347d, 348d are not scraped off and mixed with the fine powder of the product even when the material to be pulverized collide them.

Thus, according to the present embodiment, a jet mill device with excellent wear resistance due to powder can be realized.

### Variant Embodiments

The present invention is not limited to the above embodiments, and various variations are possible.

For example, the pulverizing section in the present embodiment is cylindrical, but it can be other shapes, such as spherical, hemispherical, conical, or spindle-shaped.

The number of jet nozzles, installation position, installation angle, number of protrusions, installation position, installation angle, and number of layers of various types of stacks in the present embodiment are not limited to the examples described in the present embodiment.

### EXPLANATION OF REFERENCE NUMBERS

10 Jet mill device
20 Base section
22 Compressed air tank
24 Compressed air connection port
26 Compressed air feed pipe
28 Drive motor for rotation
30 Pulverizing section
31 Cavity chamber
32 Flat plate rotor stack
34 Flat plate rotor
34a Through hole
34b Central area
34c Through hole
34d Diamond electrodeposited layer
35a Base metal (Base material)
35b Plating layer
35b Nickel plating layer
35c CBN abrasive grain
36 Spacer ring
36a Through hole
36c Through hole
37 Flat plate rotor
37a Through hole
37b Flat portion
37c Notch portion
37d Diamond electrodeposited layer
38 Flat plate rotor stack
40 Fixing ring stack
42 Underplate
42A Underplate guide ring
42a Opening
42b Diamond electrodeposited layer
42c Area
42d Threaded hole
43 Under guide ring
43a Under guide ring body
43b Diamond electrodeposited layer
43c Concave portion
43d Through hole
44 Jet ring
44a Jet ring body
44b Jet nozzle
44c Jet opening
44d Through hole
44e Convex portion
45 Jet ring
45a Jet ring body
45b Jet nozzle
45c Jet opening
45d Through hole
45e Flat surface
45f Diamond electrodeposited layer
45g Convex portion
46 Guide ring
46a Guide ring body
46b Concave portion
46c Convex portion
46d Through hole
48 Diamond electrodeposition plate
48a Plate body
48b Diamond electrodeposited layer
48c Diamond electrodeposited layer
50 Input/output section
52 Material feed tube
54 Fine powder outlet
56 Mesh section
110 Jet mill device
120 Base section
124 Compressed air connection port
130 Pulverizing section
131 Underplate
132, 134, 136 Jet ring
132a Jet ring body
132b Jet nozzle
132c Diamond electrodeposited layer
133, 135, 137 Partition plate
133a, 135a, 137a Openings
140, 141, 143, 144 Cavity chamber
150 Input/output section
152 Material input pipe
154 Fine powder outlet
210 Jet mill device
220 Base section
224 Compressed air connection port
230 Pulverizing section
231 Underplate
232 First jet ring
232a Jet ring body
232b Jet nozzle
232c Jet opening
232d Through hole
232e Opening
233, 236, 239 First partition plate
233a Partition plate body
233c Through hole
233d Through hole
233e Guide groove
234, 237, 240 Second partition plate
234a Body of partition plate
234c Through hole
234d Through hole
234e Supply hole
235, 238, 241 Second jet ring
235a Jet ring body
235b Jet nozzle
235c Jet opening
235d Through hole
235e Opening
242 Top plate
245, 246, 247, 248 Cavity chamber
245d, 246d, 247d, 248d Diamond electrodeposited layer
250 Input/output section
252 Material feed tube
254 Fine powder outlet
310 Jet mill device
320 Base section
324 Compressed air connection port
330 Pulverizing section
331 Underplate
332, 333 First jet ring
332a, 333a Jet ring body
332b, 333b Jet nozzles
332c Jet opening
332d, 333d Through hole
332e Openings
333 First partition plate
333a Partition plate body
333c Through hole
333d Through hole
333e Guide groove
334, 337 Second partition plate
334a Body of partition plate
334c Through hole
334d Through hole
334e Supply hole
335, 338 Second jet ring
335a Jet ring body
335b Jet nozzle
335c Jet opening
335d Through hole
335e Opening
336, 339 Third partition plate
336a Partition plate body
336c Through hole
336d Through hole
336e Guide groove
337, 340 Fourth partition plate
337a Partition plate body
337a Supply hole
337c Through hole
337d Through hole
337e Supply hole
342 Top plate
342a Top plate body
342c Through hole
342d Through hole
342e Guide groove
345, 346, 347, 348 Cavity chamber
345d, 346d, 347d, 348d Diamond electrodeposited layer
350 Input/output section
352 Material input pipe
354 Fine powder outlet

### INDUSTRIAL APPLICABILITY

This invention can be used in the field of pulverizing a material to be pulverized to produce fine powder.

What is claimed is:

1. A jet mill device comprising
a cavity chamber for pulverizing a material to be pulverized into a fine powder, an inner surface of the cavity chamber being formed of a material having a hardness higher than a hardness of the material to be pulverized, and
an air flow generator for generating an air flow swirled in the cavity chamber,
wherein the material to be pulverized fed into the cavity chamber is swirled by the air flow generated by the air flow generator and collides with the inner surface of the cavity chamber, thereby the material to be pulverized is pulverized into the fine powder.

2. The jet mill device according to claim 1, further comprising
a rotor body having a flat plate rotor rotating within the cavity chamber, a surface of the flat plate rotor being formed of a material having a higher hardness than that of the material to be pulverized,
wherein the material to be pulverized fed into the cavity chamber is swirled by the air flow generated by the air flow generator and collides the inner surface of the cavity chamber and the surface of the flat plate rotor, thereby the material to be pulverized is pulverized into the fine powder.

3. The jet mill device according to claim 2,
wherein the rotor body is formed by alternately stacking the flat plate rotor and a spacer, and a diameter of the spacer is smaller than a diameter of the flat plate rotor.

4. The jet mill device according to claim 1,
wherein a plurality of notches are formed on an outer circumference of the flat plate rotor of the rotor body.

5. The jet mill device according to claim 1,
wherein a plurality of stages of the cavity chamber and the air flow generator are stacked via a partition plate,
wherein the partition plate has an opening for leading the fine powder pulverized in the cavity chambers in a lower stage to the cavity chambers in an upper stage.

6. The jet mill device according to claim 5,
wherein at least three or more stages of the cavity chamber and the air flow generator are stacked via the partition plate,
wherein a diameter of the opening of the partition plate positioned between a first stage of the cavity chamber and the air flow generator, and a second stage of the cavity chamber and the air flow generator is smaller than a diameter of the opening of the partition plate positioned between the second stage of the cavity chamber and the air flow generator, and a third stage of the cavity chamber and the air flow generator.

7. The jet mill device according to claim 5,
wherein a cross-section of the cavity chamber in the lower stage is hexagon or more polygon in shape,
wherein a cross-section of the cavity chamber in the upper stage is polygon less than hexagon in shape.

8. The jet mill device according to claim 5,
wherein the cavity chamber in the upper stage comprises a plurality of small cavity chambers,
wherein the partition plate has a plurality of openings for leading the fine powder pulverized in the cavity chamber in the lower stage to the plurality of small cavity chambers in the upper stage.

9. The jet mill device according to claim 1,
wherein a diamond electrodeposited layer is formed on the inner surface of the cavity chamber or a surface of the flat plate rotor.

10. A milling method for pulverizing a material to be pulverized into a fine powder by a jet mill device comprises a cavity chamber for pulverizing the material to be pulverized into the fine powder, an inner surface of the cavity chamber being formed of a material having a hardness higher than a hardness of the material to be pulverized, and an air flow generator for generating an air flow swirled in the cavity chamber,
wherein the material to be pulverized fed into the cavity chamber is swirled by the air flow generated by the air flow generator and collides with the inner surface of the cavity chamber, whereby the material to be pulverized, thereby the material to be pulverized is pulverized into the fine powder.

11. The milling method according to claim 10,
wherein the jet mill device further comprises a rotor body having a flat plate rotor rotating within the cavity chamber, a surface of the flat plate rotor being formed of a material having a higher hardness than that of the material to be pulverized,
wherein the material to be pulverized fed into the cavity chamber is swirled by the air flow generated by the air flow generator and collides the inner surface of the cavity chamber and the surface of the flat plate rotor, thereby the material to be pulverized is pulverized into the fine powder.

12. The milling method according to claim 11,
wherein the rotor body of the jet mill device is formed by alternately stacking the flat plate rotor and a spacer, and a diameter of the spacer is smaller than a diameter of the flat plate rotor,
wherein the material to be pulverized fed into the cavity chamber is swirled by the air flow generated by the air flow generator and collides upper surfaces, outer surfaces and lower surfaces of the stacked flat plate rotors, thereby the material to be pulverized is pulverized into the fine powder.

13. The milling method according to claim 10,
wherein a plurality of notches are formed on an outer circumference of the flat plate rotor of the rotor body of the jet mill device,
wherein the material to be pulverized fed into the cavity chamber is swirled by the air flow generated by the air flow generator and collides the plurality of notches on the outer circumference of the flat plate rotor, thereby the material to be pulverized is pulverized into the fine powder.

14. The milling method according to claim 10,
wherein in the jet mill device, a plurality of stages of the cavity chamber and the air flow generator are stacked via a partition plate, and the partition plate has an opening for leading the fine powder pulverized in the cavity chambers in a lower stage to the cavity chambers in an upper stage,
wherein the material to be pulverized is fed into the the cavity chamber in the lower stage,
wherein the material to be pulverized fed into the cavity chamber in the lower stage is swirled by the air flow generated by the air flow generator in the lower stage, the material to be pulverized collides with each other and the material to be pulverized collides the inner surface of the cavity chamber and a surface of the flat plate rotor, thereby the material to be pulverized is pulverized into the fine powder,
wherein the fine powder pulverized in the cavity chamber in the lower stage is fed into the cavity chamber in the upper stage via the opening of the partition plate,
wherein the material to be pulverized fed into the cavity chamber in the upper stage is swirled by the air flow generated by the air flow generator in the upper stage, the material to be pulverized collides with each other and the material to be pulverized collides the inner surface of the cavity chamber, thereby the material to be pulverized is further pulverized into the fine powder.

15. The milling method according to claim 14,
wherein in the jet mill device, the cavity chamber in the upper stage comprises a plurality of small cavity chambers, and the partition plate has a plurality of openings for leading the fine powder pulverized in the cavity chamber in the lower stage to the plurality of small cavity chambers in the upper stage,
wherein the fine powder pulverized in the cavity chamber in the lower stage is fed into the plurality of small cavity chambers in the upper stage via the plurality of opening of the partition plate,
wherein the material to be pulverized fed into the plurality of small cavity chambers in the cavity chamber in the upper stage is swirled by the air flow generated by the air flow generator in the upper stage, the material to be pulverized collides with each other and the material to be pulverized collides the inner surface of the cavity chamber, thereby the material to be pulverized is further pulverized into the fine powder.

16. The milling method according to claim 10,
wherein a diamond electrodeposited layer is formed on the inner surface of the cavity chamber or a surface of the flat plate rotor in the jet mill device,
wherein the material to be pulverized fed into the cavity chamber collides the diamond electrodeposited layer formed on the inner surface of the cavity chamber or a surface of the flat plate rotor, thereby the material to be pulverized is pulverized into the fine powder.
